(19) United States
(12) Patent Application Publication
(10) Pub. No.: US 2025/0168830 A1
(43) Pub. Date: May 22, 2025

(54) INFORMATION CONFIGURATION METHOD AND APPARATUS, TERMINAL, NETWORK-SIDE DEVICE, AND READABLE STORAGE MEDIUM

(71) Applicant: VIVO MOBILE COMMUNICATION CO., LTD., Dongguan (CN)

(72) Inventors: Chaojun ZENG, Dongguan (CN); Lihui WANG, Dongguan (CN)

(73) Assignee: VIVO MOBILE COMMUNICATION CO., LTD., Dongguan (CN)

(21) Appl. No.: 19/033,381

(22) Filed: Jan. 21, 2025

Related U.S. Application Data
(63) Continuation of application No. PCT/CN2023/107900, filed on Jul. 18, 2023.

(30) Foreign Application Priority Data
Jul. 25, 2022 (CN) 202210879950.0

(51) Int. Cl. H04W 72/0446; H04W 72/21

(52) U.S. Cl. CPC H04W 72/0446; H04W 72/21

(57) ABSTRACT

This application provides an information configuration method and apparatus, a terminal, a network-side device, and a readable storage medium. The information configuration method includes: receiving, by a terminal, first configuration information to a network-side device. The first configuration information, at most M sets of configuration information are separately configured for one configured grant configuration (CG Config) or semi-persistent scheduling configuration (SPS Config), and each set of configuration information corresponds to time domain units satisfying a specific requirement. The first configuration information includes at most N CG Configs or SPS Configs, and each CG Config or SPS Config corresponds to time domain units satisfying a specific requirement; and M is an integer greater than 1, and N is an integer greater than 1.

### CROSS-REFERENCE TO RELATED APPLICATIONS

This application is a continuation of International Application No. PCT/CN 2023/107900, filed on Jul. 18, 2023, which claims priority to Chinese Patent Application No. 202210879950.0, filed on Jul. 25, 2022. The entire contents of each of the above-referenced applications are expressly incorporated herein by reference.

### TECHNICAL FIELD

This application relates to the field of communication technologies, and specifically, to an information configuration method and apparatus, a terminal, a network-side device, and a readable storage medium.

### BACKGROUND

To more flexibly utilize limited spectrum resources to dynamically match service requirements and improve resource utilization efficiency and performance of data transmissions such as uplink coverage and delay, a flexible duplex manner is currently proposed. The flexible duplex manner includes: full duplex at a network side, to be specific, an uplink transmission and a downlink transmission can be simultaneously performed at different frequency domain locations at a same moment; and half duplex at a terminal side, to be specific, consistent with Time Division Duplex (TDD), only an uplink transmission or a downlink transmission can be performed at a same moment, and the uplink transmission and the downlink transmission cannot be simultaneously performed. In the flexible duplex manner, both a downlink symbol and an uplink symbol of a TDD frame structure have available uplink resources, but available bandwidths, generated/received interference, and the like corresponding to these two kinds of uplink resources are different; or available bandwidths, generated/received interference, and the like corresponding to available downlink resources in different downlink symbols of the TDD frame structure are different, and if a shared channel transmission is performed based on a same configuration, performance of the shared channel transmission may be affected.

### SUMMARY

Embodiments of this application provide an information configuration method and apparatus, a terminal, a network-side device, and a readable storage medium.

According to a first aspect, an information configuration method is provided, including:
receiving, by a terminal, first configuration information from a network-side device, where
in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and N is an integer greater than 1.

According to a second aspect, an information configuration method is provided, including:
sending, by a network-side device, first configuration information to a terminal, where
in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

According to a third aspect, an information configuration apparatus is provided, applied to a terminal, the apparatus including:
a receiving module, configured to receive first configuration information from a network-side device, where
in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

According to a fourth aspect, an information configuration apparatus is provided, applied to a network-side device, the apparatus including:
a sending module, configured to send first configuration information to a terminal, where
in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

According to a fifth aspect, a terminal is provided, including a processor and a memory, where the memory stores a program or instructions runnable on the processor, and the program or the instructions, when executed by the processor, implement steps of the method according to the first aspect.

According to a sixth aspect, a terminal is provided, including a processor and a communication interface, where the communication interface is configured to receive first configuration information from a network-side device, where in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and N is an integer greater than 1.

According to a seventh aspect, a network-side device is provided, including a processor and a memory, where the memory stores a program or instructions runnable on the processor, and the program or the instructions, when executed by the processor, implement steps of the method according to the second aspect.

According to an eighth aspect, a network-side device is provided, including a processor and a communication interface, where the communication interface is configured to send first configuration information to a terminal, where in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and N is an integer greater than 1.

According to a ninth aspect, a communication system is provided, including a terminal and a network-side device, where the terminal may be configured to perform steps of the information configuration method according to the first aspect, and the network-side device may be configured to perform steps of the information configuration method according to the second aspect.

According to a tenth aspect, a readable storage medium is provided, storing a program or instructions, where the program or the instructions, when executed by a processor, implement steps of the method according to the first aspect, or implement steps of the method according to the second aspect.

According to an eleventh aspect, a chip is provided, including a processor and a communication interface, where the communication interface is coupled to the processor, and the processor is configured to run a program or instructions, to implement steps of the method according to the first aspect, or implement steps of the method according to the second aspect.

According to a twelfth aspect, a computer program/program product is provided. The computer program/program product is stored in a storage medium. The computer program/program product is executed by at least one processor to implement steps of the method according to the first aspect, or implement steps of the method according to the second aspect.

In the embodiments of this application, a terminal may receive first configuration information from a network-side device, where in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement. In this way, CG/SPS parameters may be separately configured for different uplink/downlink resources, to fully utilize the resources based on characteristics of the different uplink/downlink resources, and ensure performance of a shared channel transmission, for example, ensure performance of a CG PUSCH/SPS PDSCH transmission.

### BRIEF DESCRIPTION OF THE DRAWINGS

FIG. 1 is a block diagram of a wireless communication system to which the embodiments of this application are applicable;

FIG. 2 is a schematic diagram of a flexible duplex manner according to an embodiment of this application;

FIG. 3 is a flowchart of an information configuration method according to an embodiment of this application;

FIG. 4 is a flowchart of another information configuration method according to an embodiment of this application;

FIG. 5 is a schematic structural diagram of an information configuration apparatus according to an embodiment of this application;

FIG. 6 is a schematic structural diagram of another information configuration apparatus according to an embodiment of this application;

FIG. 7 is a schematic structural diagram of a communication device according to an embodiment of this application;

FIG. 8 is a schematic structural diagram of a terminal according to an embodiment of this application; and

FIG. 9 is a schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are some embodiments of this application rather than all of the embodiments. All other embodiments obtained by a person of ordinary skill in the art based on the embodiments of this application fall within the protection scope of this application.

The specification and claims of this application, and terms “first” and “second” are used to distinguish similar objects, but are unnecessarily used to describe a specific sequence or order. It should be understood that the terms in such a way are interchangeable in proper circumstances, so that the embodiments of this application can be implemented in other orders than the order illustrated or described herein. Objects distinguished by “first” and “second” are usually one type, and the quantity of objects is not limited. For example, the first object may be one or more than one. In addition, in the specification and the claims, “and/or” means at least one of the connected objects, and the character “/” generally indicates an “or” relationship between the associated objects.

It should be noted that, the technologies described in the embodiments of this application are not limited to a Long Term Evolution (LTE) system or an LTE-Advanced (LTE-A) system, and can also be used in other wireless communication systems, such as, Code Division Multiple Access (CDMA), Time Division Multiple Access (TDMA), Frequency Division Multiple Access (FDMA), Orthogonal Frequency Division Multiple Access (OFDMA), and Single-carrier Frequency Division Multiple Access (SC-FDMA). The terms “system” and “network” in the embodiments of this application are often used interchangeably, and the described technology can be used not only for the above systems and radio technologies, but also for other systems and radio technologies. The following description describes a New Radio (NR) system for example objectives, and NR terms are used in most of the description below, although these technologies are also applicable to applications other than NR system applications, such as a 6th Generation, (6G) communication system.

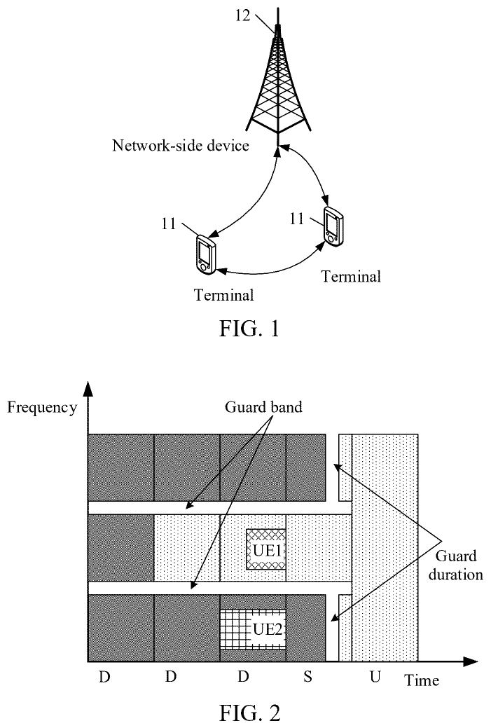

FIG. 1 is a block diagram of a wireless communication system to which the embodiments of this application are applicable. The wireless communication system includes a terminal 11 and a network-side device 12. The terminal 11 may be a terminal-side device such as a mobile phone, a tablet personal computer, a laptop computer or referred to as a notebook computer, a Personal Digital Assistant (PDA), a palmtop computer, a netbook, an Ultra-mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart home (a home device with a wireless communication function, such as a refrigerator, a TV, a washing machine, or furniture), a game console, a Personal Computer (PC), a teller machine, or a self-service machine. The wearable device includes: a smart watch, a smart band, smart earphones, smart glasses, smart jewelry (a smart bracelet, a smart chain bracelet, a smart ring, a smart necklace, a smart anklet, or a smart chain anklet), a smart wristband, a smart clothing, or the like. It should be noted that, a specific type of the terminal 11 is not limited in the embodiments of this application. The network-side device 12 may include an access network device or a core network device, where the access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, or the like. The base station may be referred to as a NodeB, an evolved nodeB (eNB), an access point, a Base Transceiver Station (BTS), a radio base station, a radio transceiver, a Basic Service Set (BSS), an Extended Service Set (ESS), a home nodeB, a home evolved nodeB, a Transmitting Receiving Point (TRP), or another appropriate term in the field, as long as the same technical effect is achieved. The base station is not limited to a specific technical term. It should be noted that, a base station in the NR system is used as an example for description in the embodiments of this application, and a specific type of the base station is not limited.

For ease of understanding the embodiments of this application, the following content is first described.

When a conventional cellular network is deployed, a Frequency Division Duplex (FDD) manner or a Time Division Duplex (TDD) manner may be used based on an available spectrum, a service characteristic, and the like. When the FDD manner is used, an uplink transmission and a downlink transmission are located at different frequencies, do not interfere with each other, and may be simultaneously performed. When the TDD manner is used, an uplink transmission and a downlink transmission are located on a same frequency and are interleaved in a time division manner. The two duplex manners have advantages and disadvantages.

To more flexibly utilize limited spectrum resources to dynamically match service requirements and improve resource utilization efficiency and performance of data transmissions such as uplink coverage and delay, a flexible duplex manner is currently proposed. The flexible duplex manner may be referred to as a non-overlapping sub-band full duplex (SBFD) manner. SBFD includes: full duplex at a network side, to be specific, an uplink transmission and a downlink transmission can be simultaneously performed at different frequency domain locations at a same moment, where a guardband may be set between frequency domain locations (corresponding to duplex sub-bands) corresponding to different transmission directions, to avoid interference between the uplink transmission and the downlink transmission; and half duplex at a terminal side, to be specific, consistent with TDD, only an uplink transmission or a downlink transmission can be performed at a same moment, and the uplink transmission and the downlink transmission cannot be simultaneously performed. It may be understood that, in the duplex manner, the uplink transmission and the downlink transmission on a network side at the same moment can only be directed to different terminals.

As shown in FIG. 2, FIG. 2 is a schematic diagram of the foregoing flexible duplex manner. The network-side device semi-statically divides, in some downlink symbols, a frequency domain of one carrier into three duplex sub-bands, where downlink duplex sub-bands are provided on two sides of the carrier, and an uplink duplex sub-band is provided in the middle of the carrier, to reduce interference to an adjacent carrier. In a third slot, User Equipment 1 (UE1) and a User Equipment 2 (UE2) respectively perform uplink sending and downlink receiving.

For example, when a cell (for example, an NR cell) is deployed on an asymmetric spectrum, the TDD manner is generally used. In this case, TDD-UL-DL-ConfigCommon may be configured in a cell common parameter, to indicate that information about a TDD frame structure includes a TDD frame periodicity, a number of complete downlink/uplink slots included in one frame periodicity, a number of downlink/uplink symbolsadditionally included outside the complete downlink/uplink Slots, and the like. For example, a parameter TDD-UL-DL-ConfigDedicated may be independently configured for each terminal by using Radio Resource Control (RRC) signaling, to further modify an uplink/downlink Symbol configuration of one or more Slots in one frame periodicity based on the TDD-UL-DL-ConfigCommon. To be specific, an initial value of the uplink/downlink Symbol configuration of the Slot is specified by the TDD-UL-DL-ConfigCommon, and then is further modified by using the TDD-UL-DL-ConfigDedicated. The modification is applied to only a terminal that receives the RRC signaling. However, the modification herein is limited to further indicating a flexible symbol in the Slot as a Downlink (DL) symbol or an Uplink (UL) symbol, and cannot be used for modifying the DL/UL symbol in the Slot in another direction. The Flexible symbol is a symbol whose transmission direction is not specified. Subsequently, whether the Flexible symbol is used for a downlink transmission or an uplink transmission may be determined as required.

The TDD-UL-DL-ConfigCommon and/or the TDD-UL-DL-ConfigDedicated is an optional configuration. Because such configuration information can only be semi-statically configured/modified based on the RRC signaling, each Symbol in one TDD frame periodicity determined based on such the configuration information is referred to as a semi-static DL/UL/flexible symbol below based on a transmission direction configured for the Symbol. In addition, the Symbol may be further abstracted into a time domain unit, and the time domain unit may correspond to a slot, a symbol, or the like. In this case, one TDD frame periodicity may include a plurality of semi-static DL/UL/flexible time domain units based on the foregoing configuration information. When the TDD-UL-DL-ConfigCommon and the TDD-UL-DL-ConfigDedicated are not configured, there is no clear concept of the TDD frame periodicity. In this case, each Slot/symbol in each radio frame of the NR cell may be understood as a semi-static flexible slot/symbol, or may be abstracted into a semi-static flexible time domain unit.

In addition, a Configured Grant (CG) transmission and a Semi-persistent Scheduling (SPS) transmission are also introduced, to mainly carry data of a periodic service, where a periodicity is relatively stable, and an amount of data that arrives/needs to be transmitted in each periodicity is relatively stable or fluctuates only within a relatively small range.

For the CG/SPS transmission, one or more configured grant configurations/semi-persistent scheduling configurations (CG Configs/SPS Configs) may be configured for one uplink/downlink (UL/DL) Bandwidth Part (BWP) of one terminal. Each CG Config/SPS Config may correspond to an independently configured periodicity, offset, time frequency resource, and the like, and an independent transmission occasion. A time domain location of the CG/SPS transmission is determined based on the periodicity/offset, or the like.

For the CG Config, at most 12 CG Configs are allowed to be configured for one UL BWP of one terminal. A periodicity of each CG Config may be a Slot class or a Symbol class. For example, during configuring, the periodicity may be uniformly measured in Symbols, and may be at least 2 Symbols. A CG Config may be further configured as a CG Config Type 1 (Type 1) or a CG Config Type 2 (Type 2). For the CG Config Type 1, an uplink grant (UL Grant) used by the CG Config Type 1 is directly configured by using RRC signaling. After an RRC configuration, corresponding Occasion and resource allocation is determined based on information about the RRC configuration. In this case, the terminal may initiate a corresponding CG Physical Uplink Shared Channel (PUSCH) transmission for each Occasion. For the CG Config Type 2, only information other than a UL Grant is configured by using RRC, and the UL Grant is indicated/activated by using activation Downlink Control Information (DCI) and is released by using release DCI. After the UL Grant is activated by the activation DCI and before the UL Grant is released by the release DCI, corresponding Occasion and resource allocation is valid. In this case, the terminal may initiate a corresponding CG PUSCH transmission for each Occasion.

For the SPS Config, at most 8 SPS Configs are allowed to be configured for one DL BWP of one terminal. A periodicity of each SPS Config may be a Slot class. For example, during configuring, the periodicity may be uniformly measured in milliseconds ms, and may be at least duration corresponding to one Slot. An operation of SPS is similar to an operation of the CG Config Type 2, that is, only information other than a downlink assignment (DL Assignment) is configured by using RRC, and the DL Assignment is indicated/activated by using the activation DCI and is released by using the release DCI. After the DL Assignment is activated by the activation DCI and before the DL Assignment is released by the release DCI, corresponding Occasion and resource allocation is valid. In this case, the terminal may receive a corresponding SPS Physical downlink shared channel (PDSCH) transmission for each Occasion, and perform a corresponding SPS Hybrid Automatic Repeat Request Acknowledgement (HARQ-ACK) feedback.

In the foregoing flexible duplex manner, both a downlink symbol and an uplink symbol of a TDD frame structure have available uplink resources, but available bandwidths, generated/received interference, and the like corresponding to these two kinds of uplink resources are different; or available bandwidths, generated/received interference, and the like corresponding to available downlink resources in different downlink symbols of the TDD frame structure (or available downlink resources planned in uplink symbols) are different. For the CG PUSCH/SPS PDSCH transmission, parameters matching relevant characteristics, for example, time frequency locations and power, may be separately configured for different uplink/downlink resources, to fully utilize the resources based on the characteristics of the different uplink/downlink resources, and ensure performance of the CG PUSCH/SPS PDSCH transmission.

In the embodiments of this application, a semi-static flexible time domain unit is a semi-static flexible time domain unit that allows a flexible duplex operation. For whether an occupancy limitation for an uplink resource corresponding to an uplink sub-band (UL sub-band) (that is, the uplink resource is necessarily limited in a frequency domain range corresponding to the UL sub-band) or an occupancy limitation for a downlink resource corresponding to a downlink sub-band (DL sub-band) (that is, the downlink resource is necessarily limited in a frequency domain range corresponding to the DL sub-band) exists in the semi-static flexible time domain unit, any of the following manners may be used:

Frequency domain limitation manner 1: The limitation exists. In the semi-static flexible time domain unit, only the frequency domain range corresponding to the UL sub-band is used as an available uplink resource, and only the frequency domain range corresponding to the DL sub-band is used as an available downlink resource.

Frequency domain limitation manner 2: No limitation exists. In the semi-static flexible time domain unit, a frequency domain range corresponding to an uplink BWP (that is, the frequency domain range corresponding to the UL sub-band is not limited) can be used as an available uplink resource, and a frequency domain range corresponding to a downlink BWP (that is, the frequency domain range corresponding to the DL sub-band is not limited) can be used as an available downlink resource, as long as other requirements of a flexible duplex manner such as non-overlapping and a guardband are satisfied.

An information configuration method and apparatus, a terminal, a network-side device, and a readable storage medium provided in the embodiments of this application are described below through some embodiments and application scenarios thereof with reference to the accompanying drawings.

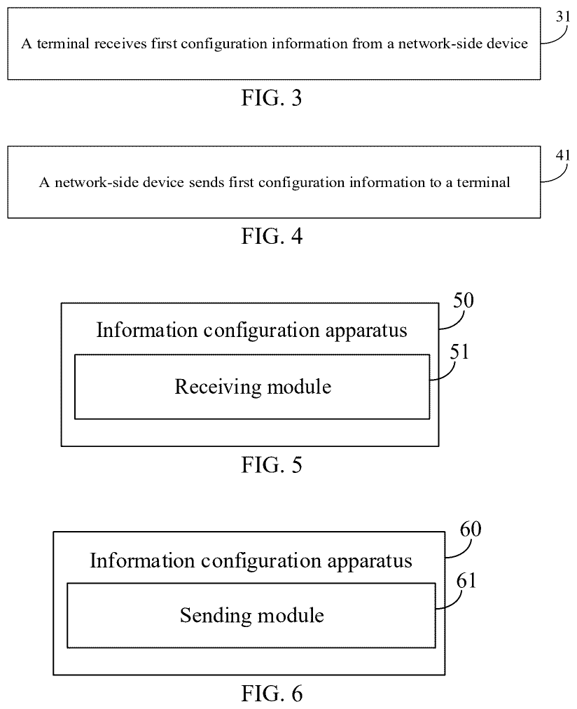

FIG. 3 is a flowchart of an information configuration method according to an embodiment of this application. The method is applied to a terminal. As shown in FIG. 3, the method includes the following steps.

Step 31: The terminal receives first configuration information from a network-side device.

In this embodiment, in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

For the SPS Config, the configuration information herein may be understood as including at least a part or all of configuration information in a parameter structure SPS-Config. For example, the configuration information herein may include a PUCCH resource n1PUCCH-AN of a HARQ-ACK feedback, an applied Modulation and Coding Scheme (MCS) table mcs-Table, and an aggregation factor pdsch-AggregationFactor-r16. The configuration information herein does not include an enabling switch of an SPS HARQ-ACK deferral. For example, considering that a flexible duplex manner can avoid or reduce dropping of an SPS HARQ-ACK caused by collision with an invalid symbol in a TDD system, to avoid or reduce implementation complexity, the terminal does not expect that the at most M sets of configuration information and the enabling switch for enabling the SPS HARQ-ACK deferral are simultaneously configured for an SPS Config.

For the CG Config, the configuration information herein may be understood as including at least a part or all of configuration information in a parameter structure ConfiguredGrantConfig. For example, the configuration information herein may include a power control parameter (for example, an open-loop power control parameter p0-PUSCH-Alpha or a closed-loop power control parameter powerControlLoopToUse), a frequency domain resource allocation parameter (for example, a resource allocation type resourceAllocation, a Resource block group (RBG) size rbg-Size of a resource allocation type 0, or a frequency hopping type frequencyHopping), an applied MCS table mcs-Table/mcs-TableTransformPrecoder, a repetition factor repK, and a code rate offset uci-OnPUSCH when Uplink Control Information (UCI) is carried.

For a CG Config Type 1, the configuration information herein may further include a part or all of configuration information in a parameter rrc-ConfiguredUplinkGrant. For example, the configuration information herein may include time domain resource allocation information (for example, time domain resource allocation timeDomainAllocation or a time domain offset timeDomainOffset), frequency domain resource allocation information (for example, frequency domain resource allocation frequencyDomainAllocation, a frequency hopping type frequencyHoppingPUSCH-RepTypeB-r16 when a PUSCH Repetition Type B is used, or a frequency hopping offset frequencyHoppingOffset), spatial domain resource allocation information (for example, antenna port configuration information antennaPort, precoding and number-of-layers configuration information precodingAndNumberOfLayers, or Sounding Reference Signal (SRS) resource configuration information srs-ResourceIndicator), MCS configuration information mcsAndTBS, and/or path loss reference configuration information pathlossReferenceIndex.

In the information configuration method in this embodiment of this application, through the foregoing first configuration information, CG/SPS parameters may be separately configured for different uplink/downlink resources, to fully utilize the resources based on characteristics of the different uplink/downlink resources, and ensure performance of a shared channel transmission, for example, ensure performance of a CG PUSCH/SPS PDSCH transmission.

For example, in the flexible duplex manner, CG parameters may be separately configured for different types of uplink resources existing in an SBFD carrier, and a corresponding CG PUSCH transmission may be performed, so that the resources can be fully utilized based on characteristics of the different uplink resources, and performance of the CG PUSCH transmission can be ensured. SPS parameters may be separately configured for different types of downlink resources existing in the SBFD carrier, and a corresponding SPS PDSCH transmission may be performed, so that the resources can be fully utilized based on characteristics of the different downlink resources, and performance of the SPS PDSCH transmission can be ensured.

For example, for the CG Config, the time domain units satisfying the specific requirement may include a first type of time domain units and/or a second type of time domain units, where the first type of time domain units includes a time domain unit having available uplink resources in a range of an uplink BWP, and the second type of time domain units includes a time domain unit having available uplink resources only in a range of an uplink sub-band.

For example, for the SPS Config, the time domain units satisfying the specific requirement may include a third type of time domain units and/or a fourth type of time domain units, where the third type of time domain units includes a time domain unit having available downlink resources in a range of a downlink BWP, and the fourth type of time domain units includes a time domain unit having available downlink resources only in a range of a downlink sub-band.

It should be noted that, the embodiments of this application are described by using an example in which four types of time domain units (for example, the first type of time domain units, the second type of time domain units, the third type of time domain units, and the fourth type of time domain unit) are involved, but these descriptions may be further generalized to cases of more than the four types of time domain units as required. For example, for the CG Config, the description may be further generalized to a case of more than two types of time domain units as required; or for the SPS Config, the description may be further generalized to a case of more than the two types of time domain units as required. In this case, a time domain unit may be correspondingly adjusted to an A^{th} type of time domain units. For a shared channel transmission in a given direction, for example, the CG PUSCH transmission or the SPS PDSCH transmission, the following another type of time domain units in this embodiment of this application is all types of time domain units except a predefined type of time domain unit/a specified type of time domain units, or any type of time domain units other than the predefined type of time domain unit/the specified type of time domain units.

For example, the first type of time domain units may include at least one of the following:

(1) Semi-static uplink time domain units.

(2) First semi-static flexible time domain units, where in a first semi-static flexible time domain unit, all frequency domain ranges corresponding to the uplink BWP can be used as available uplink resources, in other words, the frequency domain limitation manner 2 is used; and the first semi-static flexible time domain unit is a semi-static flexible time domain unit that allows a flexible duplex operation.

For example, the second type of time domain units may include at least one of the following:

(1) Semi-static downlink time domain units. The semi-static downlink time domain units herein may be understood as semi-static DL time domain units in which a UL sub-band is configured.

(2) Second semi-static flexible time domain units, where in a second semi-static flexible time domain unit, the frequency domain range corresponding to the uplink sub-band can be used as available uplink resources, in other words, the frequency domain limitation manner 1 is used; and the second semi-static flexible time domain unit is a semi-static flexible time domain unit that allows a flexible duplex operation.

For example, the third type of time domain units may include at least one of the following:

(1) Semi-static downlink time domain units.

(2) Third semi-static flexible time domain units, where in a third semi-static flexible time domain unit, all frequency domain ranges corresponding to the downlink BWP can be used as available downlink resources, in other words, the frequency domain limitation manner 2 is used; and the third semi-static flexible time domain unit is a semi-static flexible time domain unit that allows a flexible duplex operation.

For example, the fourth type of time domain units may include at least one of the following:

(1) Semi-static uplink time domain units. The semi-static uplink time domain units herein may be understood as semi-static UL time domain units in which a UL sub-band is configured.

(2) Fourth semi-static flexible time domain units, where in a fourth semi-static flexible time domain unit, the frequency domain range corresponding to the downlink sub-band can be used as available downlink resources, in other words, the frequency domain limitation manner 1 is used; and the fourth semi-static flexible time domain unit is a semi-static flexible time domain unit that allows a flexible duplex operation.

In this embodiment of this application, in the foregoing flexible duplex manner, different configuration manners may be used for a CG/SPS parameter configuration and a CG/SPS transmission, and the following description is provided.

### Configuration Manner 1

In the configuration manner, in the first configuration information, the at most M sets of configuration information are separately configured for the one CG Config or SPS Config, and each set of configuration information corresponds to/is applied to the time domain units satisfying the specific requirement.

For example, if only one set of configuration information is configured for the one CG Config, the one set of configuration information corresponds to the first type of time domain units or the second type of time domain units, for example, a time domain unit type corresponding to the one set of configuration information may be specified or configured. In some embodiments, if two sets of configuration information are configured for the one CG Config and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units. A number of sets of configuration information configured for different CG Configs may be the same or different. When only one set of configuration information is configured for each of more than one CG Config, only the first set of configuration information or the second set of configuration information may be configured for the CG Configs; or only the first set of configuration information is configured for at least one CG Config, and only the second set of configuration information is configured for other CG Configs.

For example, if only one set of configuration information is configured for the one SPS Config, the one set of configuration information corresponds to the third type of time domain units or the fourth type of time domain units, for example, a time domain unit type corresponding to the one set of configuration information may be specified or configured. In some embodiments, if two sets of configuration information are configured for the one SPS Config and the two sets of configuration information include a third set of configuration information and a fourth set of configuration information, the third set of configuration information corresponds to the third type of time domain units, and the fourth set of configuration information corresponds to the fourth type of time domain units; or the third set of configuration information corresponds to the fourth type of time domain units, and the fourth set of configuration information corresponds to the third type of time domain units. A number of sets of configuration information configured for different SPS Configs may be the same or different. When only one set of configuration information is configured for each of more than one SPS Config, only the third set of configuration information or the fourth set of configuration information may be configured for the SPS Configs; or only the third set of configuration information is configured for at least one SPS Config, and only the fourth set of configuration information is configured for other SPS Configs.

It may be understood that, when the two sets of configuration information are configured for the one CG Config, information about which there is no need to distinguish time domain unit types for configuring may be uniformly configured for all time domain units, to be specific, independent of the first set of configuration information and the second set of configuration information, the information is independently configured only once and is applied to all the time domain units; or the information may be configured in both the first set of configuration information and the second set of configuration information and have a same value. When the two sets of configuration information are configured for the one SPS Config, information about which there is no need to distinguish time domain unit types for configuring may be uniformly configured for all time domain units, to be specific, independent of the third set of configuration information and the fourth set of configuration information, the information is independently configured only once and is applied to all the time domain units; or the information may be configured in both the third set of configuration information and the fourth set of configuration information and have a same value.

It may be understood that, the configuration information herein is generally information configured by using higher layer signaling, for example, information configured in the parameter structure ConfiguredGrantConfig/SPS-Config. For a CG Config Type 2, a UL Grant further needs to be indicated by activation DCI. For example, configuration information configured for the CG Config Type 2 includes time domain resource allocation information, frequency domain resource allocation information, spatial domain resource allocation information, and MCS configuration information, which are similar to those in the configuration information in the parameter rrc-ConfiguredUplinkGrant. For an SPS Config, a DL Assignment further needs to be indicated by the activation DCI. For example, configuration information configured for the SPS Config includes time domain resource allocation information, frequency domain resource allocation information, spatial domain resource allocation information, and MCS configuration information, which are similar to those in the configuration information in the parameter rrc-ConfiguredUplinkGrant.

Based on the configuration information configured for the one CG Config or SPS Config, the following cases may be distinguished for corresponding processing.

Case 1: Only one set of configuration information is configured for the one CG Config, for example, only the first set of configuration information or the second set of configuration information is configured; or only one set of configuration information is configured for the one SPS Config, for example, only the third set of configuration information or the fourth set of configuration information is configured.

In this case, the one set of configuration information configured for the one CG Config may correspond to/be applied to the predefined type of time domain units by default. For example, when only the first set of configuration information is configured, the predefined type of time domain units may be the first type of time domain units; or when only the second set of configuration information is configured, the predefined type of time domain units may be the second type of time domain units. For example, when only the one set of configuration information is configured, the predefined type of time domain units is always the first type of time domain units or the second type of time domain units, which may be specified in a protocol, configured by using the higher layer signaling, or the like. It is assumed that when the predefined type of time domain units is the first type of time domain units, the another type of time domain units is the second type of time domain units; and when the predefined type of time domain units is the second type of time domain units, the another type of time domain units is the first type of time domain units.

The one set of configuration information configured for the one SPS Config may correspond to/be applied to the predefined type of time domain units by default. For example, when only the third set of configuration information is configured, the predefined type of time domain units may be the third type of time domain units; or when only the fourth set of configuration information is configured, the predefined type of time domain units may be the fourth type of time domain units. For example, when only the one set of configuration information is configured, the predefined type of time domain units is always the third type of time domain units or the fourth type of time domain units, which may be specified in a protocol, configured by using the higher layer signaling, or the like. It is assumed that when the predefined type of time domain units is the third type of time domain units, the another type of time domain units is the fourth type of time domain units; and when the predefined type of time domain units is the fourth type of time domain units, the another type of time domain units is the third type of time domain units.

For example, in this case, the terminal may determine an invalid transmission occasion/invalid repetition transmission in any one of the following manners:

(1) When no repetition transmission is configured, if a first transmission occasion (for example, a transmission occasion Occasion) of a first object overlaps with another type of time domain units based on second configuration information, the terminal may perform one of the following:

Determine that the first transmission occasion is illegal/invalid. In this case, the terminal ignores or does not perform a transmission of a corresponding shared channel PXSCH, where the PXSCH may be understood as a PUSCH or a PDSCH; and the another type of time domain units is used as an illegal time domain unit.

Determine that the first transmission occasion is illegal/invalid when a first predefined condition is not satisfied in at least one overlapping time domain unit of the another type (that is, at least one time domain unit in the overlapping time domain unit of the another type). In this case, the terminal ignores or does not perform a transmission of a corresponding shared channel PXSCH, where the PXSCH may be understood as a PUSCH or a PDSCH; and the another type of time domain units is used as a legal time domain unit when the first predefined condition is satisfied, otherwise the another type of time domain units is used as an illegal time domain unit.

(2) When a repetition transmission is configured, if a first repetition transmission (for example, a Repetition time domain location) of a first transmission occasion (for example, a transmission occasion Occasion) of a first object overlaps with another type of time domain units based on second configuration information, and the first repetition transmission may be any repetition transmission of the first transmission occasion, the terminal may perform one of the following:

Determine that the first repetition transmission is illegal/invalid. In this case, the terminal ignores or does not perform a transmission of a corresponding shared channel PXSCH, where the PXSCH may be understood as a PUSCH or a PDSCH; and the another type of time domain units is used as an illegal time domain unit.

Determine that the first repetition transmission is illegal/invalid when a first predefined condition is not satisfied in at least one overlapping time domain unit of the another type (that is, at least one time domain unit in the overlapping time domain unit of the another type). In this case, the terminal ignores or does not perform a transmission of a corresponding shared channel PXSCH, where the PXSCH may be understood as a PUSCH or a PDSCH; and the another type of time domain units is used as a legal time domain unit when the first predefined condition is satisfied, otherwise the another type of time domain units is used as an illegal time domain unit.

The first object includes a first CG Config or a first SPS Config. The first CG Config is one CG Config, and the first SPS Config is one SPS Config. The second configuration information is a single set of configuration information configured for the first CG Config or the first SPS Config. A type of time domain units corresponding to the second configuration information is different from a type of the another type of time domain units. For example, for the first CG Config, the time domain units corresponding to the second configuration information are the first type of time domain units, and the another type of time domain units is the second type of time domain units; or the time domain units corresponding to the second configuration information are the second type of time domain units, and the another type of time domain units is the first type of time domain units. For another example, for the first SPS Config, the time domain units corresponding to the second configuration information are the third type of time domain units, and the another type of time domain units is the fourth type of time domain units; or the time domain units corresponding to the second configuration information are the fourth type of time domain units, and the another type of time domain units is the third type of time domain units.

It should be noted that, in (1), that there is an overlap may be understood that at least one of time domain units occupied by the first transmission occasion is the another type of time domain units. A predefined method may be used for collision processing between the first transmission occasion and a time domain unit other than the first/second/third/fourth type of time domain units in this application. For example, for a PUSCH transmission, if a first transmission occasion overlaps with at least one semi-static DL time domain unit (that is, a downlink time domain unit configured by using higher layer signaling TDD-UL-DL-ConfigCommon and/or TDD-UL-DL-ConfigDedicated, without considering whether an uplink sub-band is configured in the time domain unit) and/or at least one Synchronization Signal and Physical Broadcast Channel (PBCH) Block (SSB) time domain unit (in other words, at least one of time domain units occupied by the first transmission occasion is a semi-static DL time domain unit and/or an SSB time domain unit), it is determined that the first transmission occasion is illegal or invalid. For a PDSCH transmission, if a first transmission occasion overlaps with at least one semi-static UL time domain unit (that is, an uplink time domain unit configured by using the higher layer signaling TDD-UL-DL-ConfigCommon and/or TDD-UL-DL-ConfigDedicated, without considering whether a downlink sub-band is configured in the time domain unit) (in other words, at least one of time domain units occupied by the first transmission occasion is a semi-static UL time domain unit), it is determined that the first transmission occasion is illegal or invalid. In (2), that there is an overlap may be understood that at least one of time domain units occupied by the first repetition transmission is the another type of time domain units. A predefined method may be used for collision processing between the first repetition transmission and a time domain unit other than the first/second/third/fourth type of time domain units in this application. Reference is made to the foregoing descriptions. For example, for a PUSCH transmission, the other time domain unit may include: a semi-static DL time domain unit in which a UL sub-band is not configured, and/or a semi-static flexible time domain unit that does not allow a flexible duplex operation. For a PDSCH transmission, the other time domain unit may include: a semi-static UL time domain unit in which a DL sub-band is not configured, and/or a semi-static flexible time domain unit that does not allow a flexible duplex operation.

It may be understood that, in (1) and/or (2), whether to determine the invalid transmission occasion/invalid repetition transmission by using the first predefined condition may be specified in the protocol; or may be uniformly configured for the terminal or each serving cell configured with a CG PUSCH/SPS PDSCH transmission or each UL/DL BWP configured with a CG PUSCH/SPS PDSCH transmission; or may be configured for each physical layer (Physical (PHY)) priority in a BWP; or may be configured for each CG Config/SPS Config.

In some embodiments, for a PUSCH Repetition Type B, if a Repetition of an Occasion of a CG Config/SPS Config determined based on one configured set of configuration information overlaps with another type of time domain units (in other words, at least one of time domain units occupied by the Repetition of the Occasion based on the one configured set of configuration information is the another type of time domain unit), only the overlapping time domain unit is used as an illegal time domain unit, and a segmentation operation is performed for the illegal time domain unit.

In some other embodiments, for a PUSCH Repetition Type B, if a Repetition of an Occasion of a CG Config determined based on one configured set of configuration information overlaps with another type of time domain units (in other words, at least one of time domain units occupied by the Repetition of the Occasion based on the one configured set of configuration information is the another type of time domain unit) and does not satisfy the first predefined condition in at least one overlapping time domain unit of the another type, only a time domain unit having overlapping and in which the first predefined condition is not satisfied is used as an illegal time domain unit, and a Segmentation operation is performed for the illegal time domain unit, for example, a PUSCH transmission is not performed in the illegal time domain unit. In addition, if a PUSCH transmission overlaps with at least one illegal time domain unit, the following operation may be performed: If at least one legal time domain unit consecutive in time domain is occupied before an overlapping region, a PUSCH transmission may be performed based on the at least one legal time domain unit consecutive in time domain when the given requirement is satisfied; and/or if at least one legal time domain unit consecutive in time domain is occupied after the overlapping region, a PUSCH transmission may be performed based on the at least one legal time domain unit consecutive in time domain when the given requirement is satisfied.

For example, for a second object, based on third configuration information, the terminal does not expect that a corresponding shared channel transmission or a second repetition transmission (for example, a Repetition time domain location) of the shared channel transmission overlaps with another type of time domain units, or when the shared channel transmission or the second repetition transmission (for example, the Repetition time domain location) of the shared channel transmission overlaps with another type of time domain units, the terminal does not expect that a first predefined condition is not satisfied in at least one overlapping time domain unit of the another type (that is, at least one time domain unit in the overlapping time domain unit of the another type). The second repetition transmission may be any repetition transmission of the shared channel transmission. The third configuration information is a single set of configuration information configured for a first CG Config or a first SPS Config. The first CG Config is one CG Config, and the first SPS Config is one SPS Config. The second object includes at least one of the following: a first shared channel corresponding to activation DCI, or a transmission occasion corresponding to the first CG Config or the first SPS Config. For example, the transmission occasion may be any transmission occasion. A type of time domain units corresponding to the third configuration information is different from a type of the another type of time domain units. For example, for the first CG Config, the time domain units corresponding to the third configuration information are the first type of time domain units, and the another type of time domain units is the second type of time domain units; or the time domain units corresponding to the third configuration information are the second type of time domain units, and the another type of time domain units is the first type of time domain units. For another example, for the first SPS Config, the time domain units corresponding to the third configuration information are the third type of time domain units, and the another type of time domain units is the fourth type of time domain units; or the time domain units corresponding to the third configuration information are the fourth type of time domain units, and the another type of time domain units is the third type of time domain units.

In some embodiments, for a dynamically scheduled PXSCH, or a first PXSCH corresponding to activation DCI (for example, the activation DCI is used for activating a PXSCH transmission corresponding to a CG Config (Type 2)/SPS Config, and is not applied to a CG Config Type 1), or an Occasion corresponding to a CG Config/SPS Config, the terminal does not expect that a corresponding PXSCH transmission (corresponding to no Repetition transmission configured) or a first Repetition time domain location of the corresponding PXSCH transmission (corresponding to a Repetition transmission configured) overlaps with another type of time domain units.

In some other embodiments, for a dynamically scheduled PXSCH, or a first PXSCH corresponding to activation DCI (for example, the activation DCI is used for activating a PXSCH transmission corresponding to a CG Config (Type 2)/SPS Config, and is not applied to a CG Config Type 1), or an Occasion corresponding to a CG Config/SPS Config, the terminal does not expect that a corresponding PXSCH transmission (corresponding to no Repetition transmission configured) or a first Repetition time domain location of the corresponding PXSCH transmission (corresponding to a Repetition transmission configured) overlaps with another type of time domain units, or when there is an overlap, the terminal does not expect that the first predefined condition is not satisfied in at least one overlapping time domain unit of the another type.

For example, for the first CG Config, the first predefined condition may include at least one of the following:
the another type of time domain units is the first type of time domain units; or
when the another type of time domain units is the second type of time domain units, resource elements (REs) occupied by a corresponding transmission occasion (in this case, no Repetition transmission is configured) or repetition transmission (in this case, a Repetition transmission is configured) in the overlapping time domain unit of the another type are located in a frequency domain range corresponding to the uplink sub-band.

For example, for the first SPS Config, the first predefined condition may include at least one of the following:
the another type of time domain units is the third type of time domain units; or
when the another type of time domain units is the fourth type of time domain units, REs occupied by a corresponding transmission occasion (corresponding to no Repetition transmission configured) or repetition transmission (corresponding to a Repetition transmission configured) in the overlapping time domain unit of the another type are located in a frequency domain range corresponding to the downlink sub-band.

Case 2: Two sets of configuration information are configured for the one CG Config, for example, the first set of configuration information and the second set of configuration information are configured; or two sets of configuration information are configured for the one SPS Config, for example, the third set of configuration information and the fourth set of configuration information are configured.

In this case, for the one CG Config or SPS Config, the terminal may determine applied configuration information from the two configured sets of configuration information based on at least one of the following:

(1) A type of a time domain unit in which a transmission occasion (corresponding to no Repetition transmission configured, for example, a transmission occasion Occasion) of the CG Config or SPS Config is located, or a type of a time domain unit in which a repetition transmission of a transmission occasion (corresponding to a Repetition transmission configured) of the CG Config or SPS Config is located.

For example, when a time domain unit in which an Occasion (corresponding to no Repetition transmission configured) or a Repetition time domain location of the Occasion (corresponding to a Repetition transmission configured) belongs to the first type of time domain units, the first set of configuration information configured for the corresponding CG Config is applied; or when a time domain unit in which an Occasion (corresponding to no Repetition transmission configured) or a Repetition time domain location of the Occasion (corresponding to a Repetition transmission configured) belongs to the second type of time domain units, the second set of configuration information configured for the corresponding CG Config is applied. For example, a mapping relationship between a time domain unit type and configuration information may be specified in the protocol or configured by using the higher layer signaling. The time domain unit in which the Occasion or the Repetition of the Occasion is located herein may be understood as a time domain unit occupied by the Occasion or the Repetition of the Occasion, for example, an occupied slot or symbol. Generally, the time domain unit in which the Occasion or the Repetition of the Occasion is located corresponds to only one of the first type of time domain units or the second type of time domain units. For example, a part of the time domain unit in which the Occasion or the Repetition of the Occasion is located belongs to the first type of time domain units (it is assumed that the part includes N1 time domain units), and a part belongs to the second type of time domain units (it is assumed that the part includes N2 time domain units. The case herein may be understood as that the time domain unit in which the Occasion or the Repetition of the Occasion is located corresponds to both the first type of time domain units and the second type of time domain units. In this case, a time domain unit type corresponding to a larger value of N1 and N2 may be taken, and configuration information corresponding to the time domain unit type may be applied (where when N1 and N2 are equal, a determined time domain unit type may be specified in a protocol or configured by using the higher layer signaling).

For another example, when a time domain unit in which an Occasion (corresponding to no Repetition transmission configured) or a Repetition time domain location of the Occasion (corresponding to a Repetition transmission configured) belongs to the third type of time domain units, the third set of configuration information configured for the corresponding SPS Config is applied; or when a time domain unit in which an Occasion (corresponding to no Repetition transmission configured) or a Repetition time domain location of the Occasion (corresponding to a Repetition transmission configured) belongs to the fourth type of time domain units, the fourth set of configuration information configured for the corresponding SPS Config is applied. For example, a mapping relationship between a time domain unit type and configuration information may be specified in the protocol or configured by using the higher layer signaling. The time domain unit in which the Occasion or the Repetition of the Occasion is located herein may be understood as a time domain unit occupied by the Occasion or the Repetition of the Occasion, for example, an occupied slot or symbol. Generally, the time domain unit in which the Occasion or the Repetition of the Occasion is located corresponds to only one of the third type of time domain units or the fourth type of time domain units. For example, a part of the time domain unit in which the Occasion or the Repetition of the Occasion is located belongs to the third type of time domain units (it is assumed that the part includes N3 time domain units), and a part belongs to the fourth type of time domain units (it is assumed that the part includes N4 time domain units. The case herein may be understood as that the time domain unit in which the Occasion or the Repetition of the Occasion is located corresponds to both the third type of time domain units and the fourth type of time domain units. In this case, a time domain unit type corresponding to a larger value of N3 and N4 may be taken, and configuration information corresponding to the time domain unit type may be applied (where when N3 and N4 are equal, a determined time domain unit type may be specified in a protocol or configured by using the higher layer signaling).

For another example, when a Repetition transmission is configured, applied configuration information may be determined based on a time domain unit type corresponding to a starting time domain unit of an Occasion (for example, a time domain unit in which a first Repetition of the Occasion is located, where the time domain unit herein may be a slot), and a number of repetitions may be determined based on the configuration information.

For example, for a CG Config Type 1, a used UL Grant is included in the determined applied configuration information. For a CG Config Type 2/SPS Config, a used UL Grant/DL Assignment is indicated by activation DCI.

For example, if the two sets of configuration information are configured for the one CG Config or SPS Config, the terminal may receive second activation DCI, where the second activation DCI is used for indicating any one of the following:
one used UL Grant or DL Assignment; or
a plurality of used UL Grants or DL Assignments.

For example, when the second activation DCI indicates the one used UL Grant or DL Assignment, any one of the following may be satisfied:

(i) The one UL Grant corresponds to any type of time domain units from the first type of time domain units and the second type of time domain units; or the one DL Assignment corresponds to any type of time domain units from the third type of time domain units and the fourth type of time domain units.

It may be understood that, the one UL Grant indicated by the second activation DCI may correspond to/be applied to the first type of time domain units or the second type of time domain units; or the one DL Assignment indicated by the second activation DCI may correspond to/be applied to the third type of time domain units or the fourth type of time domain units.

(ii) The one UL Grant corresponds to one type of time domain units, and a UL Grant corresponding to another type of time domain units different from the one type is derived based on the one UL Grant; or the one DL Assignment corresponds to one type of time domain units, and a DL Assignment corresponding to another type of time domain units different from the one type is derived based on the one DL Assignment.

For example, the time domain unit type to which the one UL Grant indicated by the second activation DCI is directly applied may be specified in the protocol, configured by using the higher layer signaling, or the like. For example, the one UL Grant is applied to the first type of time domain units or the second type of time domain units. The time domain unit type to which the one DL Assignment indicated by the second activation DCI is directly applied may be specified in the protocol, configured by using the higher layer signaling, or the like. For example, the one DL Assignment is applied to the third type of time domain units or the fourth type of time domain units.

For another example, when a UL Grant/DL Assignment applied to another time domain unit type is derived based on the indicated UL Grant/DL Assignment, the derivation may be performed based on a predefined rule, an DCI indication, RRC configuration information, and/or the like. For example, the another time domain unit type applies a frequency domain offset to frequency domain resource allocation information in the indicated UL Grant/DL Assignment (for example, the frequency domain offset is applied to each allocated frequency domain resource, or the frequency domain offset is applied to an entire allocated frequency domain resource set, to obtain frequency domain resource allocation information corresponding to the another time domain unit type; the frequency domain offset herein may be configured by RRC, or may be indicated by activation DCI, and may be measured in Physical Resource Blocks (PRBs), subcarriers, or the like; and it may be understood herein that, before and after the frequency domain offset is applied, a number of frequency domain resources does not change, and only a frequency domain resource location changes) to be used as actually applied frequency domain resource allocation information, and other information in the indicated UL Grant/DL Assignment is directly used.

(iii) A UL Grant corresponding to each type of time domain units is derived based on the one UL Grant; or a DL Assignment corresponding to each type of time domain units is derived based on the one DL Assignment.

It may be understood herein that, the second activation DCI indicates basic information of the UL Grant, and a UL Grant applied to each time domain unit type is derived based on the indicated UL Grant; or the activation DCI indicates basic information of the DL Assignment, and a DL Assignment applied to each time domain unit type is derived based on the indicated DL Assignment.

For example, when the second activation DCI indicates the plurality of used UL Grants or DL Assignments, each of the plurality of UL Grants corresponds to a different type of time domain units, and each of the plurality of DL Assignments corresponds to a different type of time domain units.

It may be understood herein that, the second activation DCI indicates a corresponding UL Grant/DL Assignment for each time domain unit type. For example, a first UL Grant indicated by the second activation DCI is applied to the first type of time domain units, and a second UL Grant indicated by the second activation DCI is applied to the second type of time domain units; or a first DL Assignment indicated by the second activation DCI is applied to the third type of time domain units, and a second DL Assignment indicated by the second activation DCI is applied to the fourth type of time domain units.

(2) First higher layer signaling. In other words, the applied configuration information is configured by using the higher layer signaling.

For example, which set of configuration information is applied may be uniformly configured for the terminal or each serving cell configured with a CG PUSCH/SPS PDSCH transmission or each UL/DL BWP configured with a CG PUSCH/SPS PDSCH transmission; or which set of configuration information is applied may be configured for each physical layer priority (PHY priority) in a BWP; or which set of configuration information is applied may be configured for each CG Config/SPS Config.

(3) First activation DCI. In other words, the applied configuration information is determined based on the activation DCI.

For example, which set of configuration information corresponding to a CG Config Type 2/SPS Config is applied may be determined based on the first activation DCI. The first activation DCI herein corresponds to one or more CG Config Types 2/SPS Configs.

For example, when the applied configuration information is determined based on the first activation DCI, the applied configuration information may be implicitly determined or explicitly indicated, and any one of the following may be used:

\textcircled{1} Implicitly determine the applied configuration information

For example, the applied configuration information is determined based on a type of a time domain unit in which a first shared channel (corresponding to no repetition transmission configured) corresponding to the first activation DCI is located, or the applied configuration information is determined based on a type of a time domain unit in which a first repetition transmission of the first shared channel (corresponding to a repetition transmission configured) corresponding to the first activation DCI is located.

For example, for a CG Config, which set of configuration information of the CG Config is applied may be determined based on a type of a time domain unit in which a first PUSCH (corresponding to no Repetition transmission configured) corresponding to corresponding activation DCI or a first Repetition of the first PUSCH (corresponding to a Repetition transmission configured) is located. For example, when the time domain unit in which the first PUSCH corresponding to the corresponding activation DCI or the first Repetition of the first PUSCH is located is the first type of time domain units, the first set of configuration information configured for the CG Config is applied; or when the time domain unit in which the first PUSCH corresponding to the corresponding activation DCI or the first Repetition of the first PUSCH is located is the second type of time domain units, the second set of configuration information configured for the CG Config is applied. For example, a mapping relationship between a time domain unit type and configuration information may be specified in the protocol, configured by using the higher layer signaling, or the like.

For example, for a SPS Config, which set of configuration information of the SPS Config is applied may be determined based on a type of a time domain unit in which a first PDSCH (corresponding to no Repetition transmission configured) corresponding to corresponding activation DCI or a first Repetition of the first PDSCH (corresponding to a Repetition transmission configured) is located. For example, when the time domain unit in which the first PDSCH corresponding to the corresponding activation DCI or the first Repetition of the first PDSCH is located is the third type of time domain units, the third set of configuration information configured for the SPS Config is applied; or when the time domain unit in which the first PDSCH corresponding to the corresponding activation DCI or the first Repetition of the first PDSCH is located is the fourth type of time domain units, the fourth set of configuration information configured for the SPS Config is applied. For example, a mapping relationship between a time domain unit type and configuration information may be specified in the protocol, configured by using the higher layer signaling, or the like.

\textcircled{2} Explicitly indicate the applied configuration information

For example, an indicator field in the first activation DCI may explicitly indicate which set of configuration information of the one CG Config/SPS Config is applied. The applied configuration information may satisfy any one of the following:

The applied configuration information is determined based on an indication by a first indicator field in the first activation DCI. In other words, the applied configuration information may be indicated by an independent indicator field in the first activation DCI.

For example, whether the first indicator field in the first activation DCI exists may be configured by using the higher layer signaling. When the first indicator field does not exist, default configuration information (for example, the first set of configuration information) is applied. When the first indicator field exists, a corresponding bit number may be ceiling (log₂(M)), where ceiling indicates a rounding-up operation. For example, the bit number is 1 bit when M=2.

The applied configuration information is determined based on a joint indication by a second indicator field in the first activation DCI. For example, joint coding is performed with an existing indicator field in the first activation DCI, and a codepoint in a joint indicator field indicates both information that needs to be indicated in the existing indicator field and the applied configuration information. A number of bits occupied by the joint indicator field may be expanded as required compared with a number of bits occupied by the existing indicator field.

For example, when more than one CG Config Type 2 are configured for the terminal, the existing indicator field may be a Hybrid Automatic Repeat reQuest (HARQ) process number indicator field in the activation DCI. In this case, a codepoint of the HARQ process number indicator field may indicate ConfiguredGrantConfigIndex corresponding to the activated CG Config Type 2 and an index of the applied configuration information. When more than one SPS Config are configured for the terminal, the existing indicator field may be a HARQ process number indicator field in the activation DCI. In this case, a codepoint of the HARQ process number indicator field may indicate sps-ConfigIndex corresponding to the activated SPS Config and an index of the applied configuration information.

Based on the foregoing descriptions, the manner for determining the configuration information in (3) is applicable to the CG Config Type 2 and the SPS Config, and is not applicable to the CG Config Type 1. For example, for the CG Config Type 1, other DCI (inactivation DCI, for example, Group Common DCI) may also be used for indicating the applied configuration information.

For the manners for determining the configuration information in (2) and (3), the terminal always uses the configured/indicated configuration information for the corresponding CG Config/SPS Config. For the CG Config Type 1, the used UL Grant is included in the configured/indicated configuration information. For the CG Config Type 2/SPS Config, the used UL Grant/DL Assignment is indicated by the activation DCI.

For the one CG Config, it is assumed that the one configured/indicated set of configuration information corresponds to/is applied to the specified type of time domain units. For example, when the first set of configuration information is configured/indicated to be applied, the specified type of time domain units is the first type of time domain units; and when the second set of configuration information is configured/indicated to be applied, the specified type of time domain units is the second type of time domain units. For example, a mapping relationship between a time domain unit type and configuration information may be specified in the protocol, configured by using the higher layer signaling, or the like. It is assumed that when the specified type of time domain units is the first type of time domain units, the another type of time domain units is the second type of time domain units; and when the specified type of time domain units is the second type of time domain units, the another type of time domain units is the first type of time domain units.

For the one SPS Config, it is assumed that the one configured/indicated set of configuration information corresponds to/is applied to the specified type of time domain units. For example, when the third set of configuration information is configured/indicated to be applied, the specified type of time domain units is the third type of time domain units; or when the fourth set of configuration information is configured/indicated to be applied, the specified type of time domain units is the fourth type of time domain units. For example, a mapping relationship between a time domain unit type and configuration information may be specified in the protocol, configured by using the higher layer signaling, or the like. It is assumed that when the specified type of time domain units is the third type of time domain units, the another type of time domain units is the fourth type of time domain units; and when the specified type of time domain units is the fourth type of time domain units, the another type of time domain units is the third type of time domain units.

For example, when the two sets of configuration information are configured for the one CG Config/SPS Config, the terminal may determine the invalid transmission occasion/invalid repetition transmission in any one of the following manners:

(1) When no repetition transmission is configured, if a first transmission occasion (for example, a transmission occasion Occasion) of a first object overlaps with another type of time domain units based on second configuration information, the terminal may perform one of the following:

Determine that the first transmission occasion is illegal/invalid. In this case, the terminal ignores or does not perform a transmission of a corresponding shared channel PXSCH, where the PXSCH may be understood as a PUSCH or a PDSCH; and the another type of time domain units is used as an illegal time domain unit.

Determine that the first transmission occasion is illegal/invalid when a first predefined condition is not satisfied in at least one overlapping time domain unit of the another type (that is, at least one time domain unit in the overlapping time domain unit of the another type). In this case, the terminal ignores or does not perform a transmission of a corresponding shared channel PXSCH, where the PXSCH may be understood as a PUSCH or a PDSCH; and the another type of time domain units is used as a legal time domain unit when the first predefined condition is satisfied, otherwise the another type of time domain units is used as an illegal time domain unit.

(2) When a repetition transmission is configured, if a first repetition transmission (for example, a Repetition time domain location) of a first transmission occasion (for example, a transmission occasion Occasion) of a first object overlaps with another type of time domain units based on second configuration information, and the first repetition transmission may be any repetition transmission of the first transmission occasion, the terminal may perform one of the following:

Determine that the first repetition transmission is illegal/invalid. In this case, the terminal ignores or does not perform a transmission of a corresponding shared channel PXSCH, where the PXSCH may be understood as a PUSCH or a PDSCH; and the another type of time domain units is used as an illegal time domain unit.

Determine that the first repetition transmission is illegal/invalid when a first predefined condition is not satisfied in at least one overlapping time domain unit of the another type (that is, at least one time domain unit in the overlapping time domain unit of the another type). In this case, the terminal ignores or does not perform a transmission of a corresponding shared channel PXSCH, where the PXSCH may be understood as a PUSCH or a PDSCH; and the another type of time domain units is used as a legal time domain unit when the first predefined condition is satisfied, otherwise the another type of time domain units is used as an illegal time domain unit.

The first object includes a first CG Config or a first SPS Config. The first CG Config is one CG Config, and the first SPS Config is one SPS Config. The second configuration information is one set of configuration information determined from two sets of configuration information configured for the first CG Config or the first SPS Config. For example, the one set of configuration information may be determined in any one of (1), (2), or (3). For example, (1) is used herein, which may be understood as that when a repetition transmission is configured, for an Occasion, the terminal determines, based on a starting time domain unit of the Occasion, applied configuration information from two configured sets of configuration information. A type of time domain units corresponding to the second configuration information is different from a type of the another type of time domain units. For example, for the first CG Config, the time domain units corresponding to the second configuration information are the first type of time domain units, and the another type of time domain units is the second type of time domain units; or the time domain units corresponding to the second configuration information are the second type of time domain units, and the another type of time domain units is the first type of time domain units. For another example, for the first SPS Config, the time domain units corresponding to the second configuration information are the third type of time domain units, and the another type of time domain units is the fourth type of time domain units; or the time domain units corresponding to the second configuration information are the fourth type of time domain units, and the another type of time domain units is the third type of time domain units.

It should be noted that, in (1), that there is an overlap may be understood that at least one of time domain units occupied by the first transmission occasion is the another type of time domain units. A predefined method may be used for collision processing between the first transmission occasion and a time domain unit other than the first/second/third/fourth type of time domain units in this application. Reference is made to the foregoing descriptions. In (2), that there is an overlap may be understood that at least one of time domain units occupied by the first repetition transmission is the another type of time domain units. A predefined method may be used for collision processing between the first repetition transmission and a time domain unit other than the first/second/third/fourth type of time domain units in this application. Reference is made to the foregoing descriptions. For example, for a PUSCH transmission, the other time domain unit may include: a semi-static DL time domain unit in which a UL sub-band is not configured, and/or a semi-static flexible time domain unit that does not allow a flexible duplex operation. For a PDSCH transmission, the other time domain unit may include: a semi-static UL time domain unit in which a DL sub-band is not configured, and/or a semi-static flexible time domain unit that does not allow a flexible duplex operation.

It may be understood that, in (1) and/or (2), whether to determine the invalid transmission occasion/invalid repetition transmission by using the first predefined condition may be specified in the protocol; or may be uniformly configured for the terminal or each serving cell configured with a CG PUSCH/SPS PDSCH transmission or each UL/DL BWP configured with a CG PUSCH/SPS PDSCH transmission; or may be configured for each PHY priority in a BWP; or may be configured for each CG Config/SPS Config.

For example, for a second object, based on third configuration information, the terminal does not expect that a corresponding shared channel transmission or a second repetition transmission (for example, a Repetition time domain location) of the shared channel transmission overlaps with another type of time domain units, or when the shared channel transmission or the second repetition transmission (for example, the Repetition time domain location) of the shared channel transmission overlaps with another type of time domain units, the terminal does not expect that a first predefined condition is not satisfied in at least one overlapping time domain unit of the another type (that is, at least one time domain unit in the overlapping time domain unit of the another type). The third configuration information is a single set of configuration information determined from two sets of configuration information configured for a first CG Config or a first SPS Config. The first CG Config is one CG Config, and the first SPS Config is one SPS Config. The second object includes at least one of the following: a first shared channel corresponding to activation DCI, or a transmission occasion corresponding to the first CG Config or the first SPS Config. A type of time domain units corresponding to the third configuration information is different from a type of the another type of time domain units. For example, for the first CG Config, the time domain units corresponding to the third configuration information are the first type of time domain units, and the another type of time domain units is the second type of time domain units; or the time domain units corresponding to the third configuration information are the second type of time domain units, and the another type of time domain units is the first type of time domain units. For another example, for the first SPS Config, the time domain units corresponding to the third configuration information are the third type of time domain units, and the another type of time domain units is the fourth type of time domain units; or the time domain units corresponding to the third configuration information are the fourth type of time domain units, and the another type of time domain units is the third type of time domain units.

In some embodiments, when the terminal determines a corresponding PXSCH transmission for a CG Config/SPS Config based on configured/indicated configuration information, the terminal does not expect that an Occasion (corresponding to no Repetition transmission configured) corresponding to the CG Config/SPS Config or a Repetition transmission of the Occasion (corresponding to a Repetition transmission configured) overlaps with another type of time domain units.

For example, for the first CG Config, the first predefined condition may include at least one of the following:
the another type of time domain units is the first type of time domain units; or
when the another type of time domain units is the second type of time domain units, resource elements (REs) occupied by a corresponding transmission occasion (in this case, no Repetition transmission is configured) or repetition transmission (in this case, a Repetition transmission is configured) in the overlapping time domain unit of the another type are located in a frequency domain range corresponding to the uplink sub-band.

For example, for the first SPS Config, the first predefined condition may include at least one of the following:
the another type of time domain units is the third type of time domain units; or
when the another type of time domain units is the fourth type of time domain units, REs occupied by a corresponding transmission occasion (corresponding to no Repetition transmission configured) or repetition transmission (corresponding to a Repetition transmission configured) in the overlapping time domain unit of the another type are located in a frequency domain range corresponding to the downlink sub-band.

### Configuration Manner 2

In the configuration manner, the first configuration information includes the at most N CG Configs or SPS Configs. For example, one or more CG Configs may be configured, and each CG Config corresponds to the time domain units satisfying the specific requirement; or one or more SPS Configs may be configured, and each SPS Config corresponds to the time domain units satisfying the specific requirement.

In some embodiments, a network side may configure one or more CG Configs for each BWP, and may further configure or indicate, for each CG Config, a time domain unit type to which the CG Config is applied. For example, 0, one, or more CG Configs are applied to the first type of time domain units; and/or, 0, one, or more CG Configs are applied to the second type of time domain units.

In some other embodiments, a network side may configure one or more SPS Configs for each BWP, and may further configure or indicate, for each SPS Config, a time domain unit type to which the CG Config is applied. For example, 0, one, or more SPS Configs are applied to the third type of time domain units; and/or, 0, one, or more SPS Configs are applied to the fourth type of time domain units.

For example, a limitation that currently requires that a HARQ process cannot be shared between different CG Configs of a same UL BWP can be relaxed. For example, in the flexible duplex manner, the foregoing limitation is removed, and the network side avoids a HARQ process conflict. For another example, a service identity (Service ID) is introduced for each CG Config, and HARQ process subsets corresponding to CG Configs with a same Service ID are allowed to completely overlap or overlap; and for CG Configs with different Service IDs, the foregoing limitation is used. The CG Configs with the same Service ID herein may be considered as serving a same service and being allowed to share a HARQ process. For different CG Configs in which HARQ process subsets are allowed to completely overlap or overlap, a parameter harq-ProcID-Offset2 with a same value may be configured.

For example, in the configuration manner, for a second CG Config or a second SPS Config, the second CG Config is a CG Config included in the first configuration information, for example, any CG Config; and the second SPS Config is an SPS Config included in the first configuration information, for example, any SPS Config. The terminal may determine a time domain unit type corresponding to the second CG Config or the second SPS Config based on at least one of the following:

(a) Second higher layer signaling. In other words, an applied time domain unit type is configured by using the higher layer signaling.

For example, in (a), the applied time domain unit type may be configured in any one of the following manners:

\textcircled{1} Explicit configuration. To be specific, the second higher layer signaling is used for explicitly configuring the time domain unit type corresponding to the second CG Config or the second SPS Config.

For example, an applied time domain unit type may be uniformly configured for the terminal or each Serving cell configured with a CG PUSCH/SPS PDSCH transmission or each UL/DL BWP configured with a CG PUSCH/SPS PDSCH transmission; or an applied time domain unit type may be configured for each PHY priority in a BWP; or an applied time domain unit type may be configured for each CG Config/SPS Config.

For example, a new configuration may be introduced into the parameter structure ConfiguredGrantConfig, to configure a time domain unit type to which a corresponding CG Config is applied; and/or a new configuration may be introduced into the parameter structure SPS-Config, to configure a time domain unit type to which a corresponding SPS Config is applied.

\textcircled{2} Implicit determining. To be specific, the second higher layer signaling is used for implicitly determining the time domain unit type corresponding to the second CG Config or the second SPS Config.

For example, a time domain unit type to which a corresponding CG Config is applied may be implicitly determined based on an existing parameter in the parameter structure ConfiguredGrantConfig; and/or a time domain unit type to which a corresponding SPS Config is applied may be implicitly determined based on an existing parameter in the parameter structure SPS-Config.

For example, in a case of the implicit determining, the time domain unit type corresponding to the second CG Config or the second SPS Config may be determined in any one of the following manners:

(I) The terminal determines the time domain unit type corresponding to the second CG Config or the second SPS Config based on a physical layer priority (PHY priority) configured for the second CG Config or the second SPS Config by using the second higher layer signaling.

For example, for the second CG Config, the corresponding PHY priority may be configured by using a parameter phy-PriorityIndex-r16 in the parameter structure ConfiguredGrantConfig. For the second SPS Config, the corresponding PHY priority may be configured by using a parameter harq-CodebookID-r16 in the parameter structure SPS-Config.

For example, for the second CG Config, when the PHY priority is 0, the second CG Config may be applied to the first type of time domain units; or when the PHY priority is 1, the second CG Config may be applied to the second type of time domain units, or both the first type of time domain units and the second type of time domain units, to avoid a delay. For the second SPS Config, when the PHY priority is 0, the second SPS Config may be applied to the third type of time domain units; or when the PHY priority is 1, the second SPS Config may be applied to the fourth type of time domain units, or both the third type of time domain units and the fourth type of time domain units, to avoid a delay.

(II) The terminal determines the time domain unit type corresponding to the second CG Config or the second SPS Config based on a comparison relationship between a periodicity configured for the second CG Config or the second SPS Config by using the second higher layer signaling and a first threshold.

For example, for the second CG Config, the corresponding periodicity may be configured by using a parameter periodicity or periodicityExt-r16 in the parameter structure ConfiguredGrantConfig. For the second SPS Config, the corresponding periodicity may be configured by using a parameter periodicity or periodicityExt-r16 in the parameter structure SPS-Config. The first threshold may be specified in a protocol or configured by using the higher layer signaling.

For example, for the second CG Config, when the configured periodicity is greater than or equal to the first threshold, the second CG Config may be applied to the first type of time domain units; or when the configured periodicity is less than or equal to the first threshold, the second CG Config may be applied to the second type of time domain units, or both the first type of time domain units and the second type of time domain units, to avoid a delay. For the second SPS Config, when the configured periodicity is greater than or equal to the first threshold, the second SPS Config may be applied to the third type of time domain units; or when the configured periodicity is less than or equal to the first threshold, the second SPS Config may be applied to the fourth type of time domain units, or both the third type of time domain units and the fourth type of time domain units, to avoid a delay.

(III) The terminal determines the time domain unit type corresponding to the second CG Config or the second SPS Config based on parity of an index configured for the second CG Config or the second SPS Config by using the second higher layer signaling.

For example, for the second CG Config, the corresponding index may be configured by using a parameter configuredGrantConfigIndex-r16 in the parameter structure ConfiguredGrantConfig. For the second SPS Config, the corresponding index may be configured by using a parameter sps-ConfigIndex-r16 in the parameter structure SPS-Config.

For example, for the second CG Config, when the configured index is an odd number, the second CG Config may be applied to the first type of time domain units; or when the configured index is an even number, the second CG Config may be applied to the second type of time domain units, or both the first type of time domain units and the second type of time domain units, to avoid a delay. For the second SPS Config, when the configured index is an odd number, the second SPS Config may be applied to the third type of time domain units; or when the configured index is an even number, the second SPS Config may be applied to the fourth type of time domain units, or both the third type of time domain units and the fourth type of time domain units, to avoid a delay.

(b) Third activation DCI. In other words, the applied time domain unit type is determined based on the activation DCI.

For example, a time domain unit type to which a corresponding CG Config Type 2 is applied may be determined based on the activation DCI. The activation DCI herein corresponds to one or more CG Config Types 2. In addition, in some embodiments, a time domain unit type to which a corresponding SPS Config is applied may be determined based on the activation DCI. The activation DCI herein corresponds to one or more SPS Configs.

For example, in (b), the applied time domain unit type may be determined in any one of the following manners:

\textcircled{1} Implicit determining. To be specific, the third activation DCI is used for implicitly indicating the time domain unit type corresponding to the second CG Config or the second SPS Config.

For example, the time domain unit type corresponding to the second CG Config or the second SPS Config may be any one of the following: a type of a time domain unit in which a first shared channel (corresponding to no repetition transmission configured) corresponding to the third activation DCI is located; or a type of a time domain unit in which a first repetition transmission of a first shared channel (corresponding to a repetition transmission configured) corresponding to the third activation DCI is located.

For example, the time domain unit type corresponding to the second CG Config may be any one of the following: a type of a time domain unit in which a first PUSCH (corresponding to no repetition transmission configured) corresponding to the third activation DCI is located; or a type of a time domain unit in which a first repetition transmission of a first PUSCH (corresponding to a repetition transmission configured) corresponding to the third activation DCI is located. The time domain unit type corresponding to the second SPS Config may be any one of the following: a type of a time domain unit in which a first PDSCH (corresponding to no repetition transmission configured) corresponding to the third activation DCI is located; or a type of a time domain unit in which a first repetition transmission of a first PDSCH (corresponding to a repetition transmission configured) corresponding to the third activation DCI is located.

\textcircled{2} Explicit indication. To be specific, the third activation DCI is used for explicitly indicating the time domain unit type corresponding to the second CG Config or the second SPS Config. The time domain unit type corresponding to the second CG Config or the second SPS Config may satisfy any one of the following:

The time domain unit type corresponding to the second CG Config or the second SPS Config is determined based on an indication by a third indicator field in the third activation DCI. In other words, the applied time domain unit type may be indicated by an independent indicator field in the third activation DCI.

For example, whether the third indicator field in the third activation DCI exists may be configured by using higher layer signaling. When the third indicator field does not exist, a default time domain unit type (for example, the first type of time domain unit) is applied. When the third indicator field exists, 1 bit may be occupied. For example, for the second CG Config, when a value is 0, it indicates that the second CG Config corresponds to the first type of time domain units, and when a value is 1, it indicates that the second CG Config corresponds to the second type of time domain units. For the second SPS Config, when a value is 0, it indicates that the second SPS Config corresponds to the third type of time domain units, and when a value is 1, it indicates that the second SPS Config corresponds to the fourth type of time domain units.

The time domain unit type corresponding to the second CG Config or the second SPS Config is determined based on a joint indication by a fourth indicator field in the third activation DCI. For example, joint coding is performed with an existing indicator field in the third activation DCI, and a codepoint in a joint indicator field indicates both information that needs to be indicated in the existing indicator field and the applied time domain unit type. A number of bits occupied by the joint indicator field may be expanded as required compared with a number of bits occupied by the existing indicator field.

For example, when more than one CG Config Type 2 are configured for the terminal, the existing indicator field may be a HARQ process number indicator field in the activation DCI. In this case, a codepoint of the HARQ process number indicator field may indicate ConfiguredGrantConfigIndex corresponding to the activated CG Config Type 2 and the applied time domain unit type. When more than one SPS Config are configured for the terminal, the existing indicator field may be a HARQ process number indicator field in the activation DCI. In this case, a codepoint of the HARQ process number indicator field may indicate sps-ConfigIndex corresponding to the activated SPS Config and the applied time domain unit type.

Based on the foregoing descriptions, the manner for determining the time domain unit type in (b) is applicable to the CG Config Type 2 and the SPS Config, and is not applicable to the CG Config Type 1. For example, for the CG Config Type 1, other DCI (inactivation DCI, for example, Group Common DCI) may also be used for indicating the applied configuration information.

For the manners for determining the time domain unit type in (a) and (b), a UE considers that a corresponding CG Config/SPS Config corresponds to a configured/indicated time domain unit type.

For example, for the one CG Config, assuming that the configured/indicated time domain unit type is the specified type of time domain units, the specified type of time domain units is the first type of time domain units or the second type of time domain units. For the one SPS Config, assuming that the configured/indicated time domain unit type is the specified type of time domain units, the specified type of time domain units is the third type of time domain units or the fourth type of time domain units.

For example, when the first configuration information includes the at most N CG Configs or SPS Configs, the terminal may determine an invalid transmission occasion/invalid repetition transmission in any one of the following manners:

(1) When no repetition transmission is configured, if a second transmission occasion (for example, a transmission occasion Occasion) of a third object overlaps with another type of time domain units based on fourth configuration information, the terminal may perform one of the following:

Determine that the second transmission occasion is illegal/invalid. In this case, the terminal ignores or does not perform a transmission of a corresponding shared channel PXSCH, where the PXSCH may be understood as a PUSCH or a PDSCH; and the another type of time domain units is used as an illegal time domain unit.

Determine that the second transmission occasion is illegal/invalid when a second predefined condition is not satisfied in at least one overlapping time domain unit of the another type (that is, at least one time domain unit in the overlapping time domain unit of the another type). In this case, the terminal ignores or does not perform a transmission of a corresponding shared channel PXSCH, where the PXSCH may be understood as a PUSCH or a PDSCH; and the another type of time domain units is used as a legal time domain unit when the first predefined condition is satisfied, otherwise the another type of time domain units is used as an illegal time domain unit.

(2) When a repetition transmission is configured, if a third repetition transmission (for example, a Repetition time domain location) of a second transmission occasion (for example, a transmission occasion Occasion) of a third object overlaps with another type of time domain units based on fourth configuration information, and the third repetition transmission may be any repetition transmission of the second transmission occasion, the terminal may perform one of the following:

Determine that the third repetition transmission is illegal/invalid. In this case, the terminal ignores or does not perform a transmission of a corresponding shared channel PXSCH, where the PXSCH may be understood as a PUSCH or a PDSCH; and the another type of time domain units is used as an illegal time domain unit.

Determine that the third repetition transmission is illegal/invalid when a second predefined condition is not satisfied in at least one overlapping time domain unit of the another type (that is, at least one time domain unit in the overlapping time domain unit of the another type). In this case, the terminal ignores or does not perform a transmission of a corresponding shared channel PXSCH, where the PXSCH may be understood as a PUSCH or a PDSCH; and the another type of time domain units is used as a legal time domain unit when the first predefined condition is satisfied, otherwise the another type of time domain units is used as an illegal time domain unit.

The third object includes a third CG Config or a third SPS Config. The third CG Config is a CG Config included in the first configuration information, for example, any CG Config. The third SPS Config is an SPS Config included in the first configuration information, for example, any SPS Config. The fourth configuration information is configuration information for shared channel transmissions corresponding to the third CG Config or the third SPS Config. A type of time domain units corresponding to the third CG Config is a time domain unit type configured or indicated for the third CG Config, and a type of time domain units corresponding to the third SPS Config is a time domain unit type configured or indicated for the third SPS Config. The type of the time domain units corresponding to the third CG Config or the third SPS Config is different from a type of the another type of time domain units. For example, the time domain units corresponding to the third CG Config are the first type of time domain units, and the another type of time domain units is the second type of time domain units; or the time domain units corresponding to the third CG Config are the second type of time domain units, and the another type of time domain units is the first type of time domain units. For another example, the time domain units corresponding to the third SPS Config are the third type of time domain units, and the another type of time domain units is the fourth type of time domain units; or the time domain units corresponding to the third SPS Config are the fourth type of time domain units, and the another type of time domain units is the third type of time domain units.

It should be noted that, in (1), that there is an overlap may be understood that at least one of time domain units occupied by the second transmission occasion is the another type of time domain units. A predefined method may be used for collision processing between the second transmission occasion and a time domain unit other than the first/second/third/fourth type of time domain units in this application. Reference is made to the foregoing descriptions. In (2), that there is an overlap may be understood that at least one of time domain units occupied by the third repetition transmission is the another type of time domain units. A predefined method may be used for collision processing between the third repetition transmission and a time domain unit other than the first/second/third/fourth type of time domain units in this application. Reference is made to the foregoing descriptions. For example, for a PUSCH transmission, the other time domain unit may include: a semi-static DL time domain unit in which a UL sub-band is not configured, and/or a semi-static flexible time domain unit that does not allow a flexible duplex operation. For a PDSCH transmission, the other time domain unit may include: a semi-static UL time domain unit in which a DL sub-band is not configured, and/or a semi-static flexible time domain unit that does not allow a flexible duplex operation.

It may be understood that, in (1) and/or (2), whether to determine the invalid transmission occasion/invalid repetition transmission by using the second predefined condition may be specified in the protocol; or may be uniformly configured for the terminal or each serving cell configured with a CG PUSCH/SPS PDSCH transmission or each UL/DL BWP configured with a CG PUSCH/SPS PDSCH transmission; or may be configured for each PHY priority in a BWP; or may be configured for each CG Config/SPS Config.

For example, when a fourth object uses a configured or indicated time domain unit type, the terminal does not expect that a transmission occasion (in this case, no repetition transmission is configured) corresponding to the fourth object or a repetition transmission of the transmission occasion (in this case, a repetition transmission is configured) overlaps with another type of time domain units, or when the transmission occasion corresponding to the fourth object or the repetition transmission of the transmission occasion overlaps with another type of time domain units, the terminal does not expect that a second predefined condition is not satisfied in at least one overlapping time domain unit of the another type. The fourth object includes a fourth CG Config or a fourth SPS Config. The fourth CG Config is a CG Config included in the first configuration information, and the fourth SPS Config is an SPS Config included in the first configuration information. A type of time domain units corresponding to the fourth CG Config is a time domain unit type configured or indicated for the fourth CG Config, and a type of time domain units corresponding to the fourth SPS Config is a time domain unit type configured or indicated for the fourth SPS Config. The type of the time domain units corresponding to the fourth CG Config or the fourth SPS Config is different from a type of the another type of time domain units. For example, the time domain units corresponding to the fourth CG Config are the first type of time domain units, and the another type of time domain units is the second type of time domain units; or the time domain units corresponding to the fourth CG Config are the second type of time domain units, and the another type of time domain units is the first type of time domain units. For another example, the time domain units corresponding to the fourth SPS Config are the third type of time domain units, and the another type of time domain units is the fourth type of time domain units; or the time domain units corresponding to the fourth SPS Config are the fourth type of time domain units, and the another type of time domain units is the third type of time domain units.

It may be understood that, the time domain unit type configured or indicated for the fourth object is the time domain unit type corresponding to the fourth object.

In some embodiments, when the terminal applies a configured/indicated time domain unit type for a CG Config/SPS Config, the terminal does not expect that an Occasion (in this case, no Repetition transmission is configured) corresponding to the CG Config/SPS Config or a Repetition transmission of the Occasion (in this case, a Repetition transmission is configured) overlaps with another type of time domain units; or when there is an overlap, the terminal does not expect that the second predefined condition is not satisfied in at least one overlapping time domain unit of the another type.

For example, for the third CG Config or the fourth CG Config, the second predefined condition may include at least one of the following:
the another type of time domain units is the first type of time domain units; or
when the another type of time domain units is the second type of time domain units, resource elements (REs) occupied by a corresponding transmission occasion (in this case, no Repetition transmission is configured) or repetition transmission (in this case, a Repetition transmission is configured) in the overlapping time domain unit of the another type are located in a frequency domain range corresponding to an uplink sub-band.

For example, for the third SPS Config or the fourth SPS Config, the second predefined condition may include at least one of the following:
the another type of time domain units is the third type of time domain units; or
when the another type of time domain units is the fourth type of time domain units, REs occupied by a corresponding transmission occasion (corresponding to no Repetition transmission configured) or repetition transmission (corresponding to a Repetition transmission configured) in the overlapping time domain unit of the another type are located in a frequency domain range corresponding to a downlink sub-band.

FIG. 4 is a flowchart of an information configuration method according to an embodiment of this application. The method is applied to a network-side device. As shown in FIG. 4, the method includes the following steps.

Step 41: The network-side device sends first configuration information to a terminal.

In this embodiment, in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

In this way, CG/SPS parameters may be separately configured for different uplink/downlink resources, to fully utilize the resources based on characteristics of the different uplink/downlink resources, and ensure performance of a shared channel transmission, for example, ensure performance of a CG PUSCH/SPS PDSCH transmission.

For example, for the CG Config, the time domain units satisfying the specific requirement include a first type of time domain units and/or a second type of time domain units, where the first type of time domain units includes a time domain unit having available uplink resources in a range of a BWP, and the second type of time domain units includes a time domain unit having available uplink resources only in a range of an uplink sub-band; and/or

for the SPS Config, the time domain units satisfying the specific requirement include a third type of time domain units and/or a fourth type of time domain units, where the third type of time domain units includes a time domain unit having available downlink resources in a range of a downlink BWP, and the fourth type of time domain units includes a time domain unit having available downlink resources only in a range of a downlink sub-band.

For example, the first type of time domain units includes at least one of the following:
semi-static uplink time domain units; or
first semi-static flexible time domain units, where in a first semi-static flexible time domain unit, all frequency domain ranges corresponding to the uplink BWP can be used as available uplink resources; and/or
the second type of time domain units includes at least one of the following:
semi-static downlink time domain units; or
second semi-static flexible time domain units, where in a second semi-static flexible time domain unit, only the frequency domain range corresponding to the uplink sub-band can be used as available uplink resources; and/or
the third type of time domain units includes at least one of the following:
semi-static downlink time domain units; or
third semi-static flexible time domain units, where in a third semi-static flexible time domain unit, all frequency domain ranges corresponding to the downlink BWP can be used as available downlink resources; and/or
the fourth type of time domain units includes at least one of the following:
semi-static uplink time domain units; or
fourth semi-static flexible time domain units, where in a fourth semi-static flexible time domain unit, only the frequency domain range corresponding to the downlink sub-band can be used as available downlink resources.

For example, if only one set of configuration information is configured for the one CG Config, the one set of configuration information corresponds to the first type of time domain units or the second type of time domain units; or
if two sets of configuration information are configured for the one CG Config and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units; or
if only one set of configuration information is configured for the one SPS Config, the one set of configuration information corresponds to the third type of time domain units or the fourth type of time domain units; or
if two sets of configuration information are configured for the one SPS Config and the two sets of configuration information include a third set of configuration information and a fourth set of configuration information, the third set of configuration information corresponds to the third type of time domain units, and the fourth set of configuration information corresponds to the fourth type of time domain units; or the third set of configuration information corresponds to the fourth type of time domain units, and the fourth set of configuration information corresponds to the third type of time domain units.

For example, if the two sets of configuration information are configured for the one CG Config or SPS Config, the network-side device may send first higher layer signaling and/or first activation DCI to the terminal, where the first higher layer signaling and/or the first activation DCI is used by the terminal to determine applied configuration information from the two sets of configuration information.

For example, the applied configuration information satisfies any one of the following:
the applied configuration information is determined based on a type of a time domain unit in which a first shared channel corresponding to the first activation DCI is located, or the applied configuration information is determined based on a type of a time domain unit in which a first repetition transmission of the first shared channel corresponding to the first activation DCI is located;
the applied configuration information is determined based on an indication by a first indicator field in the first activation DCI; or
the applied configuration information is determined based on a joint indication by a second indicator field in the first activation DCI.

For example, if the two sets of configuration information are configured for the one CG Config or SPS Config, the network-side device may send second activation DCI to the terminal, where the second activation DCI is used for indicating any one of the following:
one used UL Grant or DL Assignment; or
a plurality of used UL Grants or DL Assignments.

For example, when the second activation DCI indicates the one used UL Grant or DL Assignment, any one of the following is satisfied:
the one UL Grant corresponds to any type of time domain units from the first type of time domain units and the second type of time domain units, or the one DL Assignment corresponds to any type of time domain units from the third type of time domain units and the fourth type of time domain units;
the one UL Grant or DL Assignment corresponds to one type of time domain units, and a UL Grant or DL Assignment corresponding to another type of time domain units different from the one type is derived based on the one UL Grant or DL Assignment; or
a UL Grant or DL Assignment corresponding to each type of time domain units is derived based on the one UL Grant or DL Assignment.

For example, when the second activation DCI indicates the plurality of used UL Grants or DL Assignments, each of the plurality of UL Grants corresponds to a different type of time domain units, and each of the plurality of DL Assignments corresponds to a different type of time domain units.

For example, when the first configuration information includes the at most N CG Configs or SPS Configs, the network-side device may send second higher layer signaling and/or third activation DCI to the terminal, where the second higher layer signaling and/or the third activation DCI is used by the terminal to determine a time domain unit type corresponding to a second CG Config or a second SPS Config; and the second CG Config is a CG Config included in the first configuration information, and the second SPS Config is an SPS Config included in the first configuration information.

For example, the second higher layer signaling is used for explicitly configuring the time domain unit type corresponding to the second CG Config or the second SPS Config; or

the second higher layer signaling is used for implicitly determining the time domain unit type corresponding to the second CG Config or the second SPS Config.

For example, the third activation DCI is used for implicitly indicating the time domain unit type corresponding to the second CG Config or the second SPS Config; or

the third activation DCI is used for explicitly indicating the time domain unit type corresponding to the second CG Config or the second SPS Config.

An execution entity of the information configuration method provided in the embodiments of this application may be an information configuration apparatus. In the embodiments of this application, an example in which the information configuration apparatus executes the information configuration method is used to describe the information configuration apparatus provided in the embodiments of this application.

FIG. 5 is a schematic structural diagram of an information configuration apparatus according to an embodiment of this application. The apparatus is used in a terminal. As shown in FIG. 5, an information configuration apparatus 50 includes:
a receiving module 51, configured to receive first configuration information from a network-side device, where
in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

For example, for the CG Config, the time domain units satisfying the specific requirement include a first type of time domain units and/or a second type of time domain units, where the first type of time domain units includes a time domain unit having available uplink resources in a range of an uplink bandwidth part BWP, and the second type of time domain units includes a time domain unit having available uplink resources only in a range of an uplink sub-band; and/or

for the SPS Config, the time domain units satisfying the specific requirement include a third type of time domain units and/or a fourth type of time domain units, where the third type of time domain units includes a time domain unit having available downlink resources in a range of a downlink BWP, and the fourth type of time domain units includes a time domain unit having available downlink resources only in a range of a downlink sub-band.

For example, the first type of time domain units includes at least one of the following:
semi-static uplink time domain units; or
first semi-static flexible time domain units, where in a first semi-static flexible time domain unit, all frequency domain ranges corresponding to the uplink BWP can be used as available uplink resources; and/or
the second type of time domain units includes at least one of the following:
semi-static downlink time domain units; or
second semi-static flexible time domain units, where in a second semi-static flexible time domain unit, only the frequency domain range corresponding to the uplink sub-band can be used as available uplink resources; and/or
the third type of time domain units includes at least one of the following:
semi-static downlink time domain units; or
third semi-static flexible time domain units, where in a third semi-static flexible time domain unit, all frequency domain ranges corresponding to the downlink BWP can be used as available downlink resources; and/or
the fourth type of time domain units includes at least one of the following:
semi-static uplink time domain units; or
fourth semi-static flexible time domain units, where in a fourth semi-static flexible time domain unit, only the frequency domain range corresponding to the downlink sub-band can be used as available downlink resources.

For example, if only one set of configuration information is configured for the one CG Config, the one set of configuration information corresponds to the first type of time domain units or the second type of time domain units; or
if two sets of configuration information are configured for the one CG Config and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units; or
if only one set of configuration information is configured for the one SPS Config, the one set of configuration information corresponds to the third type of time domain units or the fourth type of time domain units; or
if two sets of configuration information are configured for the one SPS Config and the two sets of configuration information include a third set of configuration information and a fourth set of configuration information, the third set of configuration information corresponds to the third type of time domain units, and the fourth set of configuration information corresponds to the fourth type of time domain units; or the third set of configuration information corresponds to the fourth type of time domain units, and the fourth set of configuration information corresponds to the third type of time domain units.

For example, if two sets of configuration information are configured for the one CG Config or SPS Config, the information configuration apparatus 50 further includes:
a first determining module, configured to determine applied configuration information from the two sets of configuration information based on at least one of the following:
a type of a time domain unit in which a transmission occasion of the CG Config or SPS Config is located, or a type of a time domain unit in which a repetition transmission of a transmission occasion of the CG Config or SPS Config is located;
first higher layer signaling; or
first activation downlink control information DCI.

For example, when the applied configuration information is determined from the two sets of configuration information based on the first activation DCI, the applied configuration information satisfies any one of the following:
the applied configuration information is determined based on a type of a time domain unit in which a first shared channel corresponding to the first activation DCI is located, or the applied configuration information is determined based on a type of a time domain unit in which a first repetition transmission of the first shared channel corresponding to the first activation DCI is located;
the applied configuration information is determined based on an indication by a first indicator field in the first activation DCI; or
the applied configuration information is determined based on a joint indication by a second indicator field in the first activation DCI.

For example, if the two sets of configuration information are configured for the one CG Config or SPS Config, the receiving module 51 is further configured to receive second activation DCI, where the second activation DCI is used for indicating any one of the following:
one used uplink grant UL Grant or downlink assignment DL Assignment; or
a plurality of used UL Grants or DL Assignments.

For example, when the second activation DCI indicates the one used UL Grant or DL Assignment, any one of the following is satisfied:
the one UL Grant corresponds to any type of time domain units from the first type of time domain units and the second type of time domain units; or the one DL Assignment corresponds to any type of time domain units from the third type of time domain units and the fourth type of time domain units;
the one UL Grant corresponds to one type of time domain units, and a UL Grant corresponding to another type of time domain units different from the one type is derived based on the one UL Grant; or the one DL Assignment corresponds to one type of time domain units, and a DL Assignment corresponding to another type of time domain units different from the one type is derived based on the one DL Assignment; or
a UL Grant corresponding to each type of time domain units is derived based on the one UL Grant; or a DL Assignment corresponding to each type of time domain units is derived based on the one DL Assignment.

For example, when the second activation DCI indicates the plurality of used UL Grants or DL Assignments, each of the plurality of UL Grants corresponds to a different type of time domain units, and each of the plurality of DL Assignments corresponds to a different type of time domain units.

For example, the information configuration apparatus 50 further includes:
a first execution module, configured to perform any one of the following:
when no repetition transmission is configured, if a first transmission occasion of a first object overlaps with another type of time domain units based on second configuration information, performing one of the following: determining that the first transmission occasion is invalid, or determining that the first transmission occasion is invalid when a first predefined condition is not satisfied in at least one overlapping time domain unit of the another type; or
when a repetition transmission is configured, if a first repetition transmission of a first transmission occasion of a first object overlaps with another type of time domain units based on second configuration information, performing one of the following: determining that the first repetition transmission is invalid, or determining that the first repetition transmission is invalid when a first predefined condition is not satisfied in at least one overlapping time domain unit of the another type, where
the first object includes a first CG Config or a first SPS Config; the second configuration information is a single set of configuration information configured for the first CG Config or the first SPS Config, or the second configuration information is one set of configuration information determined from two sets of configuration information configured for the first CG Config or the first SPS Config; and a type of time domain units corresponding to the second configuration information is different from a type of the another type of time domain units.

For example, for a second object, based on third configuration information, the terminal does not expect that a corresponding shared channel transmission or a second repetition transmission of the shared channel transmission overlaps with another type of time domain units, or when the shared channel transmission or the second repetition transmission of the shared channel transmission overlaps with another type of time domain units, the terminal does not expect that a first predefined condition is not satisfied in at least one overlapping time domain unit of the another type, where

the third configuration information is a single set of configuration information configured for a first CG Config or a first SPS Config, or the third configuration information is one set of configuration information determined from two sets of configuration information configured for the first CG Config or the first SPS Config; the first CG Config is one CG Config, and the first SPS Config is one SPS Config; the second object includes at least one of the following: a first shared channel corresponding to activation DCI, or a transmission occasion corresponding to the first CG Config or the first SPS Config; and a type of time domain units corresponding to the third configuration information is different from a type of the another type of time domain units.

For example, for the first CG Config, the first predefined condition includes at least one of the following:
the another type of time domain units is the first type of time domain units; or
when the another type of time domain units is the second type of time domain units, resource elements REs occupied by a corresponding transmission occasion or repetition transmission in the overlapping time domain unit of the another type are located in a frequency domain range corresponding to the uplink sub-band; and/or
for the first SPS Config, the first predefined condition includes at least one of the following:
the another type of time domain units is the third type of time domain units; or
when the another type of time domain units is the fourth type of time domain units, REs occupied by a corresponding transmission occasion or repetition transmission in the overlapping time domain unit of the another type are located in a frequency domain range corresponding to the downlink sub-band.

For example, when the first configuration information includes the at most N CG configs or SPS configs, the information configuration apparatus 50 further includes:
a second determining module, configured to determine a time domain unit type corresponding to a second CG Config or a second SPS Config based on at least one of the following:
second higher layer signaling; or
third activation DCI, where
the second CG Config is a CG Config included in the first configuration information, and the second SPS Config is an SPS Config included in the first configuration information.

For example, the second higher layer signaling is used for explicitly configuring the time domain unit type corresponding to the second CG Config or the second SPS Config; or

the second higher layer signaling is used for implicitly determining the time domain unit type corresponding to the second CG Config or the second SPS Config.

For example, when the second higher layer signaling is used for implicitly determining the time domain unit type corresponding to the second CG Config or the second SPS Config, the second determining module is further configured to perform at least one of the following:
determining the time domain unit type corresponding to the second CG Config or the second SPS Config based on a physical layer priority configured for the second CG Config or the second SPS Config by using the second higher layer signaling;
determining the time domain unit type corresponding to the second CG Config or the second SPS Config based on a comparison relationship between a periodicity configured for the second CG Config or the second SPS Config by using the second higher layer signaling and a first threshold; or
determining the time domain unit type corresponding to the second CG Config or the second SPS Config based on parity of an index configured for the second CG Config or the second SPS Config by using the second higher layer signaling.

For example, the third activation DCI is used for implicitly indicating the time domain unit type corresponding to the second CG Config or the second SPS Config; or

the third activation DCI is used for explicitly indicating the time domain unit type corresponding to the second CG Config or the second SPS Config.

For example, when the third activation DCI is used for implicitly indicating the time domain unit type corresponding to the second CG Config or the second SPS Config, the time domain unit type corresponding to the second CG Config or the second SPS Config is any one of the following: a type of a time domain unit in which a first shared channel corresponding to the third activation DCI is located; or a type of a time domain unit in which a first repetition transmission of a first shared channel corresponding to the third activation DCI is located; or
when the third activation DCI is used for explicitly indicating the time domain unit type corresponding to the second CG Config or the second SPS Config, the time domain unit type corresponding to the second CG Config or the second SPS Config satisfies any one of the following:
the time domain unit type corresponding to the second CG Config or the second SPS Config is determined based on an indication by a third indicator field in the third activation DCI; or
the time domain unit type corresponding to the second CG Config or the second SPS Config is determined based on a joint indication by a fourth indicator field in the third activation DCI.

For example, when the first configuration information includes the at most N CG configs or SPS configs, the information configuration apparatus 50 further includes:
a second execution module, configured to perform any one of the following:
when no repetition transmission is configured, if a second transmission occasion of a third object overlaps with another type of time domain units based on fourth configuration information, performing one of the following: determining that the second transmission occasion is invalid, or determining that the second transmission occasion is invalid when a second predefined condition is not satisfied in at least one overlapping time domain unit of the another type; or
when a repetition transmission is configured, if a third repetition transmission of a second transmission occasion of a third object overlaps with another type of time domain units based on fourth configuration information, performing one of the following: determining that the third repetition transmission is invalid, or determining that the third repetition transmission is invalid when a second predefined condition is not satisfied in at least one overlapping time domain unit of the another type, where
the third object includes a third CG Config or a third SPS Config, the fourth configuration information is configuration information for shared channel transmissions corresponding to the third CG Config or the third SPS Config, the third CG Config is a CG Config included in the first configuration information, and the third SPS Config is an SPS Config included in the first configuration information; and the type of the time domain units corresponding to the third CG Config or the third SPS Config is different from a type of the another type of time domain units.

For example, when a fourth object uses a configured or indicated time domain unit type, the terminal does not expect that a transmission occasion corresponding to the fourth object or a repetition transmission of the transmission occasion overlaps with another type of time domain units, or when the transmission occasion corresponding to the fourth object or the repetition transmission of the transmission occasion overlaps with another type of time domain units, the terminal does not expect that a second predefined condition is not satisfied in at least one overlapping time domain unit of the another type, where the fourth object includes a fourth CG Config or a fourth SPS Config, the fourth CG Config is a CG Config included in the first configuration information, and the fourth SPS Config is an SPS Config included in the first configuration information; and the type of the time domain units corresponding to the fourth CG Config or the fourth SPS Config is different from a type of the another type of time domain units.

For example, for the third CG Config or the fourth CG Config, the second predefined condition includes at least one of the following:
the another type of time domain units is the first type of time domain units; or
when the another type of time domain units is the second type of time domain units, REs occupied by a corresponding transmission occasion or repetition transmission in the overlapping time domain unit of the another type are located in a frequency domain range corresponding to an uplink sub-band; and/or
for the third SPS Config or the fourth SPS Config, the second predefined condition includes at least one of the following:
the another type of time domain units is the third type of time domain units; or
when the another type of time domain units is the fourth type of time domain units, REs occupied by a corresponding transmission occasion or repetition transmission in the overlapping time domain unit of the another type are located in a frequency domain range corresponding to a downlink sub-band.

The information configuration apparatus 50 in this embodiment of this application may be an electronic device, such as an electronic device with an operating system; or may be a component in an electronic device, such as an integrated circuit or a chip. The electronic device may be a terminal or another device other than the terminal. For example, the terminal may include, but is not limited to, the types of the terminal 11 listed above, and the another device may be a server, a Network Attached Storage (NAS), or the like, which are not specifically limited in the embodiments of this application.

The information configuration apparatus 50 provided in this embodiment of this application can implement all processes implemented in the method embodiment shown in FIG. 3, and can achieve the same technical effects. To avoid repetition, details are not described herein again.

FIG. 6 is a schematic structural diagram of an information configuration apparatus according to an embodiment of this application. The apparatus is used in a network-side device. As shown in FIG. 6, an information configuration apparatus 60 includes:
a sending module 61, configured to send first configuration information to a terminal, where
in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and Nis an integer greater than 1.

For example, for the CG Config, the time domain units satisfying the specific requirement include a first type of time domain units and/or a second type of time domain units, where the first type of time domain units includes a time domain unit having available uplink resources in a range of a BWP, and the second type of time domain units includes a time domain unit having available uplink resources only in a range of an uplink sub-band; and/or

for the SPS Config, the time domain units satisfying the specific requirement include a third type of time domain units and/or a fourth type of time domain units, where the third type of time domain units includes a time domain unit having available downlink resources in a range of a downlink BWP, and the fourth type of time domain units includes a time domain unit having available downlink resources only in a range of a downlink sub-band.

For example, the first type of time domain units includes at least one of the following:
semi-static uplink time domain units; or
first semi-static flexible time domain units, where in a first semi-static flexible time domain unit, all frequency domain ranges corresponding to the uplink BWP can be used as available uplink resources; and/or
the second type of time domain units includes at least one of the following:
semi-static downlink time domain units; or
second semi-static flexible time domain units, where in a second semi-static flexible time domain unit, only the frequency domain range corresponding to the uplink sub-band can be used as available uplink resources; and/or
the third type of time domain units includes at least one of the following:
semi-static downlink time domain units; or
third semi-static flexible time domain units, where in a third semi-static flexible time domain unit, all frequency domain ranges corresponding to the downlink BWP can be used as available downlink resources; and/or
the fourth type of time domain units includes at least one of the following:
semi-static uplink time domain units; or
fourth semi-static flexible time domain units, where in a fourth semi-static flexible time domain unit, only the frequency domain range corresponding to the downlink sub-band can be used as available downlink resources.

For example, if only one set of configuration information is configured for the one CG Config, the one set of configuration information corresponds to the first type of time domain units or the second type of time domain units; or
if two sets of configuration information are configured for the one CG Config and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units; or
if only one set of configuration information is configured for the one SPS Config, the one set of configuration information corresponds to the third type of time domain units or the fourth type of time domain units; or
if two sets of configuration information are configured for the one SPS Config and the two sets of configuration information include a third set of configuration information and a fourth set of configuration information, the third set of configuration information corresponds to the third type of time domain units, and the fourth set of configuration information corresponds to the fourth type of time domain units; or the third set of configuration information corresponds to the fourth type of time domain units, and the fourth set of configuration information corresponds to the third type of time domain units.

For example, if the two sets of configuration information are configured for the one CG Config or SPS Config, the sending module 61 is further configured to send first higher layer signaling and/or first activation DCI to the terminal, where the first higher layer signaling and/or the first activation DCI is used by the terminal to determine applied configuration information from the two sets of configuration information.

For example, the applied configuration information satisfies any one of the following:
the applied configuration information is determined based on a type of a time domain unit in which a first shared channel corresponding to the first activation DCI is located, or the applied configuration information is determined based on a type of a time domain unit in which a first repetition transmission of the first shared channel corresponding to the first activation DCI is located;
the applied configuration information is determined based on an indication by a first indicator field in the first activation DCI; or
the applied configuration information is determined based on a joint indication by a second indicator field in the first activation DCI.

For example, if the two sets of configuration information are configured for the one CG Config or SPS Config, the sending module 61 is further configured to send second activation DCI to the terminal, where the second activation DCI is used for indicating any one of the following:
one used UL Grant or DL Assignment; or
a plurality of used UL Grants or DL Assignments.

For example, when the second activation DCI indicates the one used UL Grant or DL Assignment, any one of the following is satisfied:
the one UL Grant corresponds to any type of time domain units from the first type of time domain units and the second type of time domain units, or the one DL Assignment corresponds to any type of time domain units from the third type of time domain units and the fourth type of time domain units;
the one UL Grant or DL Assignment corresponds to one type of time domain units, and a UL Grant or DL Assignment corresponding to another type of time domain units different from the one type is derived based on the one UL Grant or DL Assignment; or
a UL Grant or DL Assignment corresponding to each type of time domain units is derived based on the one UL Grant or DL Assignment.

For example, when the second activation DCI indicates the plurality of used UL Grants or DL Assignments, each of the plurality of UL Grants corresponds to a different type of time domain units, and each of the plurality of DL Assignments corresponds to a different type of time domain units.

For example, when the first configuration information includes the at most N CG Configs or SPS Configs, the sending module 61 is further configured to send second higher layer signaling and/or third activation DCI to the terminal, where the second higher layer signaling and/or the third activation DCI is used by the terminal to determine a time domain unit type corresponding to a second CG Config or a second SPS Config; and the second CG Config is a CG Config included in the first configuration information, and the second SPS Config is an SPS Config included in the first configuration information.

For example, the second higher layer signaling is used for explicitly configuring the time domain unit type corresponding to the second CG Config or the second SPS Config; or

the second higher layer signaling is used for implicitly determining the time domain unit type corresponding to the second CG Config or the second SPS Config.

For example, the third activation DCI is used for implicitly indicating the time domain unit type corresponding to the second CG Config or the second SPS Config; or

the third activation DCI is used for explicitly indicating the time domain unit type corresponding to the second CG Config or the second SPS Config.

The information configuration apparatus 60 provided in this embodiment of this application can implement procedures implemented in the method embodiment shown in FIG. 4, and can achieve the same technical effects. To avoid repetition, details are not described herein again.

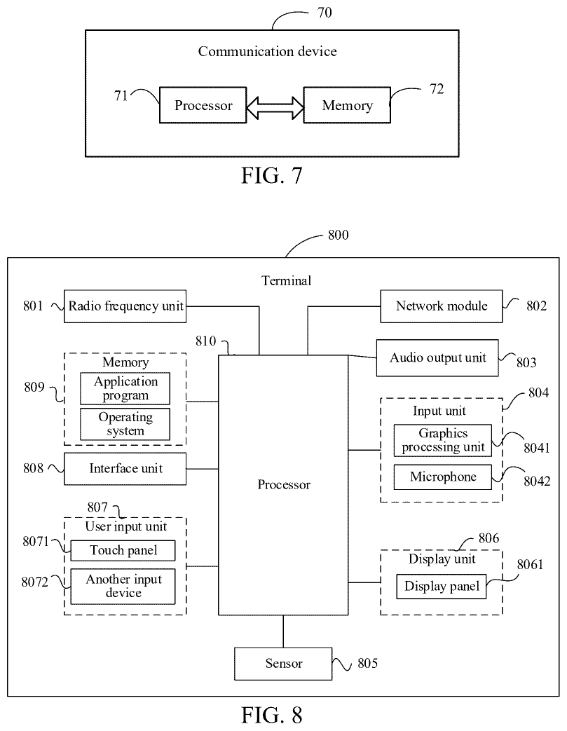

For example, as shown in FIG. 7, an embodiment of this application further provides a communication device 70, including a processor 71, a memory 72, where the memory 72 stores a program or instructions runnable on the processor 71. For example, when the communication device 70 is a terminal, the program or the instructions, when executed by the processor 71, implement all steps of the embodiment of the information configuration method shown in FIG. 3, and can achieve the same technical effects. When the communication device 70 is a network-side device, the program or the instructions, when executed by the processor 71, implement all steps of the embodiment of the information configuration method shown in FIG. 4, and can achieve the same technical effects. To avoid repetition, details are not described herein again.

An embodiment of this application further provides a terminal, including a processor and a communication interface, where the communication interface is configured to receive first configuration information from a network-side device, where in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and N is an integer greater than 1. The terminal embodiment corresponds to the foregoing terminal side method embodiment, and each implementation process and implementation of the foregoing method embodiment can be applied to the terminal embodiment, and can achieve the same technical effects.

For example, FIG. 8 is a schematic diagram of a hardware structure of a terminal that implements the embodiments of this application.

A terminal 800 includes, but is not limited to, at least part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 further includes a power supply (such as a battery) for supplying power to the components. The power supply may logically connect to the processor 810 by using a power supply management system, thereby implementing functions, such as charging, discharging, and power consumption management, by using the power supply management system. The terminal structure shown in FIG. 8 does not constitute a limitation to the terminal, and the terminal may include more or fewer components than illustrated, or a combination of specific components, or arrangement of different components, which are not described herein again.

It should be understood that, in this embodiment of this application, the input unit 804 may include a Graphics Processing Unit (GPU) 8041 and a microphone 8042. The graphics processing unit 8041 processes image data of a still picture or a video obtained by an image capture apparatus (such as a camera) in a video capture mode or an image capture mode. The display unit 806 may include a display panel 8061, for example, the display panel 8061 may be configured in a form such as a liquid crystal display or an organic light-emitting diode. The user input unit 807 includes at least one of a touch panel 8071 or another input device 8072. The touch panel 8071 is also referred to as a touchscreen. The touch panel 8071 may include two parts: a touch detection apparatus and a touch controller. The another input device 8072 may include, but is not limited to, a physical keyboard, a functional key (for example, a volume control key or a switch key), a track ball, a mouse, and a joystick, and the details will not be described herein again.

In this embodiment of this application, the radio frequency unit 801 may transmit, after receiving downlink data from a network-side device, the downlink data to the processor 810 for processing. In addition, the radio frequency unit 801 may send uplink data to the network-side device. Generally, the radio frequency unit 801 includes, but is not limited to, an antenna, an amplifier, a transceiver, a coupler, a low noise amplifier, a duplexer, or the like.

The memory 809 may be configured to store a software program or instructions, and various data. The memory 809 may mainly include a first storage area for storing the program or the instructions and a second storage area for storing data, where the first storage area may store an operating system, an application program or instructions required for at least one function (for example, a sound playing function and an image playing function), or the like. In addition, the memory 809 may include a volatile memory or a non-volatile memory, or the memory 809 may include both the volatile memory and the non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), or a Direct Rambus RAM (DR RAM). The memory 809 in this embodiment of this application includes but is not limited to these memories and any other suitable types of memories.

The processor 810 may include one or more processing units. For example, the processor 810 integrates an application processor and a modem. The application processor mainly processes operations related to an operating system, a user interface, an application program, and the like. The modem mainly processes a wireless communication signal, such as a baseband processor. It may be understood that, the foregoing modem may not be integrated into the processor 810.

The radio frequency unit 801 is configured to receive first configuration information from a network-side device, where in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and N is an integer greater than 1.

The terminal 800 provided in this embodiment of this application can implement all processes implemented by the embodiment of the method shown in FIG. 3, and can achieve the same technical effects. To avoid repetition, details are not described herein again.

An embodiment of this application further provides a network-side device, including a processor and a communication interface, where the communication interface is configured to send first configuration information to a terminal, where in the first configuration information, at most M sets of configuration information are separately configured for one CG Config or SPS Config, and each set of configuration information corresponds to time domain units satisfying a specific requirement; or the first configuration information includes at most N CG Configs or SPS Configs, and each CG Config or SPS Config corresponds to time domain units satisfying a specific requirement; and M is an integer greater than 1, and N is an integer greater than 1. The network-side device embodiment corresponds to the foregoing network-side device method embodiment, and each implementation process and implementation of the foregoing method embodiment can be applied to the network-side device embodiment, and can achieve the same technical effects.

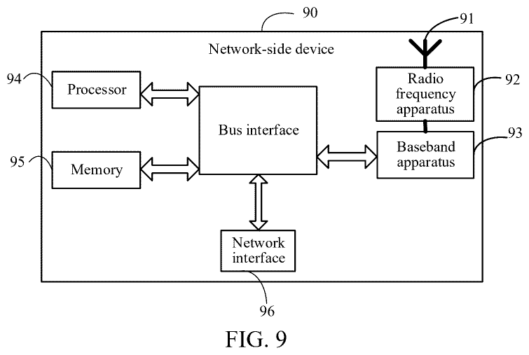

For example, an embodiment of this application further provides a network-side device. As shown in FIG. 9, the network-side device 90 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information by using the antenna 91, and sends the received information to the baseband apparatus 93 for processing. In a downlink direction, the baseband apparatus 93 processes information that is to be sent, and sends the information to the radio frequency apparatus 92. The radio frequency apparatus 92 processes the received information and sends the information by using the antenna 91.

The method executed by the network-side device in the foregoing embodiment can be implemented in the baseband apparatus 93. The baseband apparatus 93 includes a baseband processor.

For example, the baseband apparatus 93 may include at least one baseband board, and a plurality of chips are disposed on the baseband board. As shown in FIG. 9, one chip, for example, the baseband processor, is connected to the memory 95 through a bus interface, to invoke a program in the memory 95, to execute operations of network devices shown in the foregoing method embodiments.

The network-side device may further include a network interface 96. The interface is, for example, a Common Public Radio Interface (CPRI).

For example, the network-side device 90 in this embodiment of this application further includes: instructions or a program stored in the memory 95 and runnable on the processor 94, and the processor 94 invokes the instructions or the program stored in the memory 95 to perform the method executed by various modules shown in FIG. 6, and can achieve the same technical effects. To avoid repetition, details are not described herein again.

An embodiment of this application further provides a readable storage medium, storing a program or instructions. The program or the instructions, when executed by a processor, implement all processes of the embodiment of the information configuration method shown in FIG. 3, or implement all processes of the embodiment of the information configuration method shown in FIG. 4, and can achieve the same technical effects. To avoid repetition, details are not described herein again.

The processor is the processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip, including a processor and a communication interface, where the communication interface is coupled to the processor, and the processor is configured to run a program or instructions, to implement all processes of the embodiment of the information configuration method shown in FIG. 3, or implement all processes of the embodiment of the information configuration method shown in FIG. 4, and can achieve the same technical effects. To avoid repetition, details are not described herein again.

It should be understood that, the chip mentioned in this embodiment of this application may also be referred to as a system-level chip, a system chip, a chip system, a system on chip, or the like.

An embodiment of this application further provides a computer program/program product, stored in a storage medium. The computer program/program product is executed by at least one processor to implement all processes of the embodiments of the information configuration method, and can achieve the same technical effects. To avoid repetition, details are not described herein again.

An embodiment of this application further provides a communication system, including a terminal and a network-side device. The terminal may be configured to perform steps of the information configuration method shown in FIG. 3, and the network-side device may be configured to perform steps of the information configuration method shown in FIG. 4.

It should be noted that, the term “include”, “comprise”, or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one . . . ” does not exclude that there are still other same elements in the processes, methods, objects, or apparatuses. In addition, it should be noted that the scope of the methods and apparatuses in the implementations of this application is not limited to performing the functions in the order shown or discussed, but may also include performing, according to involved functions, the functions basically simultaneously or in a reverse order. For example, the described methods may be performed in an order different from that described, and various steps may also be added, omitted, or combined. In addition, a feature described with reference to an example may be combined in another example.

Through the descriptions of the foregoing implementations, a person skilled in the art may clearly understand that the method according to the foregoing embodiments may be implemented through software and a necessary general hardware platform, and, may be implemented by hardware, but in many cases, the former manner is a better implementation. Based on such an understanding, the technical solutions in this application essentially or the part contributing to the related arts may be implemented in the form of a software product. The computer software product is stored in a storage medium (for example, a Read-Only Memory (ROM)/Random Access Memory (RAM), a magnetic disk or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. An information configuration method, comprising:
receiving, by a terminal, first configuration information from a network-side device, wherein
in the first configuration information, at most M sets of configuration information are separately configured for one configured grant configuration (CG Config) or semi-persistent scheduling configuration (SPS Config), and each set of configuration information corresponds to time domain units satisfying a specific requirement; or
the first configuration information comprises at most N CG Configs or SPS Configs, and each CG Config or SPS Config corresponds to time domain units satisfying a specific requirement,
wherein M is an integer greater than 1, and N is an integer greater than 1.

2. The information configuration method according to claim 1, wherein
for the CG Config, the time domain units satisfying the specific requirement comprise a first type of time domain units or a second type of time domain units, wherein the first type of time domain units comprises a time domain unit having available uplink resources in a range of an uplink Bandwidth Part (BWP), and the second type of time domain units comprises a time domain unit having available uplink resources only in a range of an uplink sub-band,
or
for the SPS Config, the time domain units satisfying the specific requirement comprise a third type of time domain units or a fourth type of time domain units, wherein the third type of time domain units comprises a time domain unit having available downlink resources in a range of a downlink BWP, and the fourth type of time domain units comprises a time domain unit having available downlink resources only in a range of a downlink sub-band.

3. The information configuration method according to claim 2, wherein the first type of time domain units comprises at least one of the following:
semi-static uplink time domain units; or
first semi-static flexible time domain units, wherein in a first semi-static flexible time domain unit, all frequency domain ranges corresponding to the uplink BWP can be used as available uplink resources,
or
the second type of time domain units comprises at least one of the following:
semi-static downlink time domain units; or
second semi-static flexible time domain units, wherein in a second semi-static flexible time domain unit, only the frequency domain range corresponding to the uplink sub-band can be used as available uplink resources,
or
the third type of time domain units comprises at least one of the following:
semi-static downlink time domain units; or
third semi-static flexible time domain units, wherein in a third semi-static flexible time domain unit, all frequency domain ranges corresponding to the downlink BWP can be used as available downlink resources,
or
the fourth type of time domain units comprises at least one of the following:
semi-static uplink time domain units; or
fourth semi-static flexible time domain units, wherein in a fourth semi-static flexible time domain unit, only the frequency domain range corresponding to the downlink sub-band can be used as available downlink resources.

4. The information configuration method according to claim 2, wherein
when only one set of configuration information is configured for the one CG Config, the one set of configuration information corresponds to the first type of time domain units or the second type of time domain units,
or
when two sets of configuration information are configured for the one CG Config and the two sets of configuration information comprise a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units,
or
when only one set of configuration information is configured for the one SPS Config, the one set of configuration information corresponds to the third type of time domain units or the fourth type of time domain units,
or
when two sets of configuration information are configured for the one SPS Config and the two sets of configuration information comprise a third set of configuration information and a fourth set of configuration information, the third set of configuration information corresponds to the third type of time domain units, and the fourth set of configuration information corresponds to the fourth type of time domain units; or the third set of configuration information corresponds to the fourth type of time domain units, and the fourth set of configuration information corresponds to the third type of time domain units.

5. The information configuration method according to claim 4, wherein when the two sets of configuration information are configured for the one CG Config or SPS Config, the method further comprises:
determining, by the terminal, applied configuration information from the two sets of configuration information based on at least one of the following:
a type of a time domain unit in which a transmission occasion of the CG Config or SPS Config is located, or a type of a time domain unit in which a repetition transmission of a transmission occasion of the CG Config or SPS Config is located;
first higher layer signaling; or
first activation Downlink Control Information (DCI).

6. The information configuration method according to claim 5, wherein when the applied configuration information is determined from the two sets of configuration information based on the first activation DCI, the applied configuration information satisfies any one of the following:
the applied configuration information is determined based on a type of a time domain unit in which a first shared channel corresponding to the first activation DCI is located, or the applied configuration information is determined based on a type of a time domain unit in which a first repetition transmission of the first shared channel corresponding to the first activation DCI is located;
the applied configuration information is determined based on an indication by a first indicator field in the first activation DCI; or
the applied configuration information is determined based on a joint indication by a second indicator field in the first activation DCI.

7. The information configuration method according to claim 5, wherein when the two sets of configuration information are configured for the one CG Config or SPS Config, the method further comprises:
receiving, by the terminal, second activation DCI, wherein
the second activation DCI is used for indicating any one of the following:
one used uplink (UL) Grant or downlink (DL) Assignment; or
a plurality of used UL Grants or DL Assignments.

8. The information configuration method according to claim 7, wherein when the second activation DCI indicates the one used UL Grant or DL Assignment, any one of the following is satisfied:
the one UL Grant corresponds to any type of time domain units from the first type of time domain units and the second type of time domain units; or the one DL Assignment corresponds to any type of time domain units from the third type of time domain units and the fourth type of time domain units,
the one UL Grant corresponds to one type of time domain units, and a UL Grant corresponding to another type of time domain units different from the one type is derived based on the one UL Grant; or the one DL Assignment corresponds to one type of time domain units, and a DL Assignment corresponding to another type of time domain units different from the one type is derived based on the one DL Assignment, or
a UL Grant corresponding to each type of time domain units is derived based on the one UL Grant; or a DL Assignment corresponding to each type of time domain units is derived based on the one DL Assignment.

9. The information configuration method according to claim 4, further comprising any one of the following:
when no repetition transmission is configured, and when a first transmission occasion of a first object overlaps with another type of time domain units based on second configuration information, performing, by the terminal, one of the following:
determining that the first transmission occasion is invalid; or
determining that the first transmission occasion is invalid when a first predefined condition is not satisfied in at least one overlapping time domain unit of the another type, or
when a repetition transmission is configured, and when a first repetition transmission of a first transmission occasion of a first object overlaps with another type of time domain units based on second configuration information, performing, by the terminal, one of the following:
determining that the first repetition transmission is invalid; or
determining that the first repetition transmission is invalid when a first predefined condition is not satisfied in at least one overlapping time domain unit of the another type,
wherein the first object comprises a first CG Config or a first SPS Config; the second configuration information is a single set of configuration information configured for the first CG Config or the first SPS Config, or the second configuration information is one set of configuration information determined from two sets of configuration information configured for the first CG Config or the first SPS Config; and a type of time domain units corresponding to the second configuration information is different from a type of the another type of time domain units.

10. The information configuration method according to claim 1, wherein when the first configuration information comprises the at most N CG configs or SPS configs, the method further comprises:
determining, by the terminal, a time domain unit type corresponding to a second CG Config or a second SPS Config based on at least one of the following:
second higher layer signaling; or
third activation DCI,
wherein the second CG Config is a CG Config comprised in the first configuration information, and the second SPS Config is an SPS Config comprised in the first configuration information.

11. The information configuration method according to claim 10, wherein the third activation DCI is used for implicitly indicating the time domain unit type corresponding to the second CG Config or the second SPS Config, or the third activation DCI is used for explicitly indicating the time domain unit type corresponding to the second CG Config or the second SPS Config,
or
wherein when the third activation DCI is used for implicitly indicating the time domain unit type corresponding to the second CG Config or the second SPS Config, the time domain unit type corresponding to the second CG Config or the second SPS Config is any one of the following:
a type of a time domain unit in which a first shared channel corresponding to the third activation DCI is located; or
a type of a time domain unit in which a first repetition transmission of a first shared channel corresponding to the third activation DCI is located,
or
wherein when the third activation DCI is used for explicitly indicating the time domain unit type corresponding to the second CG Config or the second SPS Config, the time domain unit type corresponding to the second CG Config or the second SPS Config satisfies any one of the following:
the time domain unit type corresponding to the second CG Config or the second SPS Config is determined based on an indication by a third indicator field in the third activation DCI; or
the time domain unit type corresponding to the second CG Config or the second SPS Config is determined based on a joint indication by a fourth indicator field in the third activation DCI.

12. The information configuration method according to claim 1, wherein when the first configuration information comprises the at most N CG configs or SPS configs, the method further comprises any one of the following:
when no repetition transmission is configured, and when a second transmission occasion of a third object overlaps with another type of time domain units based on fourth configuration information, performing, by the terminal, one of the following:
determining that the second transmission occasion is invalid; or
determining that the second transmission occasion is invalid when a second predefined condition is not satisfied in at least one overlapping time domain unit of the another type, or
when a repetition transmission is configured, and when a third repetition transmission of a second transmission occasion of a third object overlaps with another type of time domain units based on fourth configuration information, performing, by the terminal, one of the following:
determining that the third repetition transmission is invalid; or
determining that the third repetition transmission is invalid when a second predefined condition is not satisfied in at least one overlapping time domain unit of the another type,
wherein
the third object comprises a third CG Config or a third SPS Config, the fourth configuration information is configuration information for shared channel transmissions corresponding to the third CG Config or the third SPS Config, the third CG Config is a CG Config comprised in the first configuration information, and the third SPS Config is an SPS Config comprised in the first configuration information; a type of time domain units corresponding to the third CG Config is a time domain unit type configured or indicated for the third CG Config, and a type of time domain units corresponding to the third SPS Config is a time domain unit type configured or indicated for the third SPS Config; and
the type of the time domain units corresponding to the third CG Config or the third SPS Config is different from a type of the another type of time domain units.

13. An information configuration method, comprising:
sending, by a network-side device, first configuration information to a terminal, wherein
in the first configuration information, at most M sets of configuration information are separately configured for one configured grant configuration (CG Config) or semi-persistent scheduling configuration (SPS Config), and each set of configuration information corresponds to time domain units satisfying a specific requirement; or the first configuration information comprises at most N CG Configs or SPS Configs, and each CG Config or SPS Config corresponds to time domain units satisfying a specific requirement; and M is an integer greater than 1, and N is an integer greater than 1.

14. The information configuration method according to claim 13, wherein for the CG Config, the time domain units satisfying the specific requirement comprise a first type of time domain units or a second type of time domain units, wherein the first type of time domain units comprises a time domain unit having available uplink resources in a range of an uplink Bandwidth Part (BWP), the second type of time domain units comprises a time domain unit having available uplink resources only in a range of an uplink sub-band,
or
wherein for the SPS Config, the time domain units satisfying the specific requirement comprise a third type of time domain units or a fourth type of time domain units, wherein the third type of time domain units comprises a time domain unit having available downlink resources in a range of a downlink BWP, the fourth type of time domain units comprises a time domain unit having available downlink resources only in a range of a downlink sub-band.

15. The information configuration method according to claim 14, wherein when only one set of configuration information is configured for the one CG Config, the one set of configuration information corresponds to the first type of time domain units or the second type of time domain units,
or
wherein when two sets of configuration information are configured for the one CG Config and the two sets of configuration information comprise a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units;
or
wherein when only one set of configuration information is configured for the one SPS Config, the one set of configuration information corresponds to the third type of time domain units or the fourth type of time domain units;
or
wherein when two sets of configuration information are configured for the one SPS Config and the two sets of configuration information comprise a third set of configuration information and a fourth set of configuration information, the third set of configuration information corresponds to the third type of time domain units, and the fourth set of configuration information corresponds to the fourth type of time domain units; or the third set of configuration information corresponds to the fourth type of time domain units, and the fourth set of configuration information corresponds to the third type of time domain units.

16. The information configuration method according to claim 15, wherein when the two sets of configuration information are configured for the one CG Config or SPS Config, the method further comprises:
sending, by the network-side device, first higher layer signaling or first activation Downlink Control Information (DCI) to the terminal, wherein
the first higher layer signaling or the first activation DCI is used by the terminal to determine applied configuration information from the two sets of configuration information,
wherein the applied configuration information satisfies any one of the following:
the applied configuration information is determined based on a type of a time domain unit in which a first shared channel corresponding to the first activation DCI is located, or the applied configuration information is determined based on a type of a time domain unit in which a first repetition transmission of the first shared channel corresponding to the first activation DCI is located;
the applied configuration information is determined based on an indication by a first indicator field in the first activation DCI; or
the applied configuration information is determined based on a joint indication by a second indicator field in the first activation DCI.

17. The information configuration method according to claim 14, wherein when the two sets of configuration information are configured for the one CG Config or SPS Config, the method further comprises:
sending, by the network-side device, second activation DCI to the terminal, wherein
the second activation DCI is used for indicating any one of the following:
one used uplink (UL) Grant or downlink (DL) Assignment; or
a plurality of used UL Grants or DL Assignments.

18. The information configuration method according to claim 17, wherein when the second activation DCI indicates the one used UL Grant or DL Assignment, any one of the following is satisfied:
the one UL Grant corresponds to any type of time domain units from the first type of time domain units and the second type of time domain units, or the one DL Assignment corresponds to any type of time domain units from the third type of time domain units and the fourth type of time domain units;
the one UL Grant or DL Assignment corresponds to one type of time domain units, and a UL Grant or DL Assignment corresponding to another type of time domain units different from the one type is derived based on the one UL Grant or DL Assignment; or
a UL Grant or DL Assignment corresponding to each type of time domain units is derived based on the one UL Grant or DL Assignment.

19. The information configuration method according to claim 13, wherein when the first configuration information comprises the at most N CG configs or SPS configs, the method further comprises:
sending, by the network-side device, second higher layer signaling or third activation DCI to the terminal, wherein
the second higher layer signaling or the third activation DCI is used by the terminal to determine a time domain unit type corresponding to a second CG Config or a second SPS Config, the second CG Config is a CG Config comprised in the first configuration information, the second SPS Config is an SPS Config comprised in the first configuration information.

20. A terminal, comprising a processor and a memory storing instructions, wherein the instructions, when executed by the processor, cause the processor to perform operations comprising:
receiving first configuration information from a network-side device, wherein
in the first configuration information, at most M sets of configuration information are separately configured for one configured grant configuration (CG Config) or semi-persistent scheduling configuration (SPS Config), and each set of configuration information corresponds to time domain units satisfying a specific requirement; or
the first configuration information comprises at most N CG Configs or SPS Configs, and each CG Config or SPS Config corresponds to time domain units satisfying a specific requirement,
wherein M is an integer greater than 1, and N is an integer greater than 1.
